(19) United States
(12) Patent Application Publication
(10) Pub. No.: US 2026/0213903 A1
(43) Pub. Date: Jul. 23, 2026

(54) Signal Transmission Method and Communication Apparatus

(71) Applicant: Huawei Technologies Co., Ltd., Shenzhen (CN)

(72) Inventors: Xiaoyan Bi, Shanghai (CN); Jianglei Ma, Ottawa (CA); Lei Liu, Shanghai (CN)

(73) Assignee: Huawei Technologies Co., Ltd., Shenzhen (CN)

(21) Appl. No.: 19/572,029

(22) Filed: Mar. 19, 2026

Related U.S. Application Data
(63) Continuation of application No. PCT/CN2023/119992, filed on Sep. 20, 2023.

(51) Int. Cl. H04L 5/00

(52) U.S. Cl. CPC H04L 5/005

(57) ABSTRACT

A signal transmission method includes: A first device receives first indication information, where the first indication information is used to determine a resource pattern of a reference signal, the resource pattern of the reference signal includes at least one first basic pattern, and the first indication information indicates a relationship between the first basic pattern and a reference resource pattern, for example, indicates whether the first basic pattern is updated relative to the reference resource pattern; and receives or sends the reference signal based on the first indication information. Based on this, the first device can determine each basic pattern based on the reference resource pattern and the relationship between the first basic pattern and the reference resource pattern, to determine the resource pattern of the reference signal based on each basic pattern.

### CROSS-REFERENCE TO RELATED APPLICATIONS

This is a continuation of Int'l Patent App. No. PCT/CN2023/119992, filed on Sep. 20, 2023, which is incorporated by reference.

### FIELD

This disclosure relates to the communication field, and more specifically, to a signal transmission method and a communication apparatus.

### BACKGROUND

A multiple-input multiple-output (MIMO) technology is one of key technologies in the 5th generation (5G) communication and future communication. In the MIMO technology, a plurality of transmit antennas at a transmit end and a plurality of receive antennas at a receive end respectively send and receive signals, to implement multiple-transmit multiple-receive, thereby improving communication quality.

To send and receive data, obtain system synchronization, feed back channel information, and the like, reference signals are transmitted between the transmit end and the receive end. For example, the transmit end sends a reference signal to the receive end, and the receive end receives the reference signal, so that corresponding operations can be performed based on reference signal. Therefore, how to obtain configuration information of the reference signal, for example, a resource pattern of the reference signal, is a problem worth considering.

### SUMMARY

This disclosure provides a signal transmission method and a communication apparatus, to reduce signaling overheads caused by indicating a resource pattern of a reference signal.

According to a first aspect, a signal transmission method is provided, and the method may be performed by an apparatus. The apparatus may be a device (for example, a terminal device or a network device), or may be a component (for example, a chip, a chip system, or a circuit) of the device.

The method may include: receiving first indication information, where the first indication information is used to determine a resource pattern of a reference signal, the resource pattern of the reference signal includes at least one first basic pattern, and the first indication information indicates a relationship between the first basic pattern and a reference resource pattern; and receiving or sending the reference signal based on the first indication information.

Based on the foregoing technical solution, the first indication information used to determine the resource pattern of the reference signal specifically indicates a relationship between each basic pattern forming the resource pattern of the reference signal and the reference resource pattern. In this way, each basic pattern may be determined based on the relationship and the reference resource pattern, and the resource pattern of the reference signal may be further determined based on each basic pattern. Compared with a solution in which the resource pattern of the reference signal is directly indicated, this solution can reduce signaling overheads caused by indicating the resource pattern of the reference signal. In addition, this solution is more flexible, and may be applied to more communication scenarios. For example, this solution is also applicable to a scenario in which a resource pattern of a reference signal is not evenly distributed or a scenario in which a resource pattern of a reference signal is sparsely distributed.

With reference to the first aspect, in some implementations of the first aspect, the first indication information includes first information, and that the first indication information indicates the relationship between the first basic pattern and the reference resource pattern includes: The first information indicates whether the first basic pattern is updated relative to the reference resource pattern.

With reference to the first aspect, in some implementations of the first aspect, the first information indicates that the first basic pattern is updated relative to the reference resource pattern, the first indication information further includes second information, and the second information indicates the first basic pattern.

Based on the foregoing technical solution, the resource pattern of the reference signal can be indicated by two levels of signaling (namely, the first information and the second information). Specifically, first-level signaling (namely, the first information) indicates whether a basic pattern (namely, the first basic pattern) is updated relative to the reference resource pattern. If the basic pattern is updated relative to the reference resource pattern, second-level signaling (namely, the second information) indicates the basic pattern. In this manner, signaling overheads caused by indicating the resource pattern of the reference signal can be reduced.

With reference to the first aspect, in some implementations of the first aspect, the first information indicates that a first parameter in configuration information of the first basic pattern is updated relative to a first parameter in configuration information of the reference resource pattern, and the second information indicates the first parameter in the configuration information of the first basic pattern.

Based on the foregoing technical solution, if the basic pattern is updated relative to the reference resource pattern, the second information may directly indicate an updated parameter in the configuration information of the basic pattern. In this way, signaling overheads can be further reduced.

With reference to the first aspect, in some implementations of the first aspect, the reference resource pattern includes at least one second basic pattern, and that the first indication information indicates the relationship between the first basic pattern and the reference resource pattern includes: The first indication information indicates a relationship between the first basic pattern and the second basic pattern.

With reference to the first aspect, in some implementations of the first aspect, the configuration information of the first basic pattern includes one or more of the following information: a start position of the first basic pattern, a domain corresponding to the first basic pattern, and a resource that is of the reference signal and that is indicated by the first basic pattern, where the domain corresponding to the first basic pattern is any one of the following: a time domain, a frequency domain, and a space domain.

For example, that the first indication information indicates the relationship between the first basic pattern and the reference resource pattern indicates that the first indication information indicates a relationship between the configuration information of the first basic pattern and the configuration information of the reference resource pattern.

Based on the foregoing technical solution, the resource pattern of the reference signal may be learned of by using the configuration information of the first basic pattern.

With reference to the first aspect, in some implementations of the first aspect, the resource that is of the reference signal and that is indicated by the first basic pattern includes at least one of the following information: a total quantity of resources corresponding to the first basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the first basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

With reference to the first aspect, in some implementations of the first aspect, the method further includes: receiving second indication information, where the second indication information indicates at least one bandwidth resource, and the at least one bandwidth resource is associated with the resource pattern of the reference signal.

That the at least one bandwidth resource is associated with the resource pattern of the reference signal may be understood as that the resource pattern of the reference signal is applicable to the at least one bandwidth resource, or the resource pattern of the reference signal is a pattern of the reference signal on the at least one bandwidth resource.

For example, one bandwidth resource is a part of a resource of a bandwidth part (BWP). A resource of one BWP may include the at least one bandwidth resource.

Based on the foregoing technical solution, the first indication information may indicate the resource pattern of the reference signal on the at least one bandwidth resource. Compared with indicating the resource pattern of the reference signal on each bandwidth resource, this solution can further reduce signaling overheads.

With reference to the first aspect, in some implementations of the first aspect, the at least one bandwidth resource includes a first bandwidth resource and a second bandwidth resource, and a resource pattern of the reference signal on the second bandwidth resource is the same as a resource pattern of the reference signal on the first bandwidth resource; or the first indication information includes the first information, the first information indicates whether the first basic pattern is updated relative to the reference resource pattern, and first information corresponding to the second bandwidth resource is the same as first information corresponding to the first bandwidth resource; or a relationship between a first basic pattern corresponding to the second bandwidth resource and the reference resource pattern is the same as a relationship between a first basic pattern corresponding to the first bandwidth resource and the reference resource pattern.

With reference to the first aspect, in some implementations of the first aspect, before receiving the first indication information, the method further includes: sending third indication information, where the third indication information indicates a recommended resource pattern of the reference signal.

For example, for the third indication information, refer to a related solution of the first indication information.

With reference to the first aspect, in some implementations of the first aspect, the reference resource pattern is the recommended resource pattern of the reference signal.

With reference to the first aspect, in some implementations of the first aspect, the resource pattern of the reference signal is a resource pattern of the reference signal on a first resource, and the reference resource pattern is a resource pattern of the reference signal on a second resource, where the first resource is different from the second resource; or the reference resource pattern is a predefined or preconfigured pattern.

With reference to the first aspect, in some implementations of the first aspect, that the reference resource pattern is the resource pattern of the reference signal on the second resource includes any one of the following: The reference resource pattern is a resource pattern of the reference signal on at least one time domain unit, the reference resource pattern is a resource pattern of the reference signal on at least one frequency domain unit, the reference resource pattern is a resource pattern of the reference signal on at least one antenna port, or the reference resource pattern is a resource pattern of the reference signal on at least one antenna port group.

According to a second aspect, a signal transmission method is provided, and the method may be performed by an apparatus. The apparatus may be a device (for example, a terminal device or a network device), or may be a component (for example, a chip, a chip system, or a circuit) of the device.

The method may include: sending first indication information, where the first indication information is used to determine a resource pattern of a reference signal, the resource pattern of the reference signal includes at least one first basic pattern, and the first indication information indicates a relationship between the first basic pattern and a reference resource pattern; and receiving or sending the reference signal based on the first indication information.

With reference to the second aspect, in some implementations of the second aspect, the first indication information includes first information, and that the first indication information indicates the relationship between the first basic pattern and the reference resource pattern includes: The first information indicates whether the first basic pattern is updated relative to the reference resource pattern.

With reference to the second aspect, in some implementations of the second aspect, the first information indicates that the first basic pattern is updated relative to the reference resource pattern, the first indication information further includes second information, and the second information indicates the first basic pattern.

With reference to the second aspect, in some implementations of the second aspect, the first information indicates that a first parameter in configuration information of the first basic pattern is updated relative to a first parameter in configuration information of the reference resource pattern, and the second information indicates the first parameter in the configuration information of the first basic pattern.

With reference to the second aspect, in some implementations of the second aspect, the reference resource pattern includes at least one second basic pattern, and that the first indication information indicates the relationship between the first basic pattern and the reference resource pattern includes: The first indication information indicates a relationship between the first basic pattern and the second basic pattern.

With reference to the second aspect, in some implementations of the second aspect, the configuration information of the first basic pattern includes one or more of the following information: a start position of the first basic pattern, a domain corresponding to the first basic pattern, and a resource that is of the reference signal and that is indicated by the first basic pattern, where the domain corresponding to the first basic pattern is any one of the following: a time domain, a frequency domain, and a space domain.

With reference to the second aspect, in some implementations of the second aspect, the resource that is of the reference signal and that is indicated by the first basic pattern includes at least one of the following information: a total quantity of resources corresponding to the first basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the first basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

With reference to the second aspect, in some implementations of the second aspect, the method further includes: sending second indication information, where the second indication information indicates at least one bandwidth resource, and the at least one bandwidth resource is associated with the resource pattern of the reference signal.

With reference to the second aspect, in some implementations of the second aspect, the at least one bandwidth resource includes a first bandwidth resource and a second bandwidth resource, and a resource pattern of the reference signal on the second bandwidth resource is the same as a resource pattern of the reference signal on the first bandwidth resource; or the first indication information includes the first information, the first information indicates whether the first basic pattern is updated relative to the reference resource pattern, and first information corresponding to the second bandwidth resource is the same as first information corresponding to the first bandwidth resource; or a relationship between a first basic pattern corresponding to the second bandwidth resource and the reference resource pattern is the same as a relationship between a first basic pattern corresponding to the first bandwidth resource and the reference resource pattern.

With reference to the second aspect, in some implementations of the second aspect, before receiving the first indication information, the method further includes: receiving third indication information, where the third indication information indicates a recommended resource pattern of the reference signal.

With reference to the second aspect, in some implementations of the second aspect, the reference resource pattern is the recommended resource pattern of the reference signal.

With reference to the second aspect, in some implementations of the second aspect, the resource pattern of the reference signal is a resource pattern of the reference signal on a first resource, and the reference resource pattern is a resource pattern of the reference signal on a second resource, where the first resource is different from the second resource; or the reference resource pattern is a predefined or preconfigured pattern.

With reference to the second aspect, in some implementations of the second aspect, that the reference resource pattern is the resource pattern of the reference signal on the second resource includes any one of the following: The reference resource pattern is a resource pattern of the reference signal on at least one time domain unit, the reference resource pattern is a resource pattern of the reference signal on at least one frequency domain unit, the reference resource pattern is a resource pattern of the reference signal on at least one antenna port, or the reference resource pattern is a resource pattern of the reference signal on at least one antenna port group.

According to a third aspect, a signal transmission method is provided, and the method may be performed by an apparatus. The apparatus may be a device (for example, a terminal device or a network device), or may be a component (for example, a chip, a chip system, or a circuit) of the device.

The method may include: sending third indication information, where the third indication information indicates a first resource pattern of a reference signal, the first resource pattern of the reference signal includes at least one third basic pattern, and the third indication information indicates a relationship between the third basic pattern and a first reference resource pattern; and receiving or sending the reference signal based on a response to the third indication information.

The first resource pattern of the reference signal may be understood as a recommended resource pattern, for example, the recommended resource pattern of the reference signal in the first aspect.

Based on the foregoing technical solution, the device may recommend a resource pattern of the reference signal. For example, the third indication information indicates the first resource pattern of the reference signal. The third indication information specifically indicates a relationship between each basic pattern (namely, a third basic pattern) of the resource pattern (namely, the first resource pattern) forming the reference signal and the reference resource pattern (namely, the first reference resource pattern). In this way, each basic pattern may be determined based on the relationship and the reference resource pattern, and the resource pattern of the reference signal may be further determined based on each basic pattern. Compared with a solution in which the resource pattern of the reference signal is directly indicated, this solution can reduce signaling overheads caused by indicating the resource pattern of the reference signal. In addition, this solution may be applied to more communication scenarios. For example, this solution is also applicable to a scenario in which a resource pattern of a reference signal is not evenly distributed or a scenario in which a resource pattern of a reference signal is sparsely distributed.

With reference to the third aspect, in some implementations of the third aspect, receiving or sending the reference signal based on the response to the third indication information includes: receiving acknowledgment information of the third indication information, where the acknowledgment information indicates that the resource pattern of the reference signal is the first resource pattern; and receiving or sending the reference signal based on the first resource pattern.

With reference to the third aspect, in some implementations of the third aspect, receiving or sending the reference signal based on the response to the third indication information includes: receiving first indication information, where the first indication information is used to determine a second resource pattern of the reference signal, the resource pattern of the reference signal includes at least one first basic pattern, and the first indication information indicates a relationship between the first basic pattern and a second reference resource pattern; and receiving or sending the reference signal based on the second resource pattern of the reference signal.

For example, the second reference resource pattern is the first resource pattern or the third basic pattern.

For this implementation, for example, the third indication information or the first basic pattern, refer to the descriptions in the first aspect.

With reference to the third aspect, in some implementations of the third aspect, the third indication information includes first information, and that the third indication information indicates the relationship between the third basic pattern and the first reference resource pattern includes: The first information indicates whether the third basic pattern is updated relative to the first reference resource pattern.

With reference to the third aspect, in some implementations of the third aspect, the first information indicates that the third basic pattern is updated relative to the first reference resource pattern, the third indication information further includes second information, and the second information indicates the third basic pattern.

With reference to the third aspect, in some implementations of the third aspect, the first information indicates that a first parameter in configuration information of the third basic pattern is updated relative to a first parameter in configuration information of the first reference resource pattern, and the second information indicates the first parameter in the configuration information of the third basic pattern.

With reference to the third aspect, in some implementations of the third aspect, the first reference resource pattern includes at least one second basic pattern, and that the third indication information indicates the relationship between the third basic pattern and the first reference resource pattern includes: The third indication information indicates a relationship between the third basic pattern and the second basic pattern.

With reference to the third aspect, in some implementations of the third aspect, the configuration information of the third basic pattern includes one or more of the following information: a start position of the third basic pattern, a domain corresponding to the third basic pattern, and a resource that is of the reference signal and that is indicated by the third basic pattern, where the domain corresponding to the third basic pattern is any one of the following: a time domain, a frequency domain, and a space domain.

With reference to the third aspect, in some implementations of the third aspect, the resource that is of the reference signal and that is indicated by the third basic pattern includes at least one of the following information: a total quantity of resources corresponding to the third basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the third basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

With reference to the third aspect, in some implementations of the third aspect, the method further includes: receiving second indication information, where the second indication information indicates at least one bandwidth resource, and the at least one bandwidth resource is associated with the resource pattern of the reference signal.

With reference to the third aspect, in some implementations of the third aspect, the at least one bandwidth resource includes a first bandwidth resource and a second bandwidth resource, and a resource pattern of the reference signal on the second bandwidth resource is the same as a resource pattern of the reference signal on the first bandwidth resource; or the third indication information includes the first information, the first information indicates whether the third basic pattern is updated relative to the first reference resource pattern, and first information corresponding to the second bandwidth resource is the same as first information corresponding to the first bandwidth resource; or a relationship between a third basic pattern corresponding to the second bandwidth resource and the first reference resource pattern is the same as a relationship between a third basic pattern corresponding to the first bandwidth resource and the first reference resource pattern.

With reference to the third aspect, in some implementations of the third aspect, the resource pattern of the reference signal is a resource pattern of the reference signal on a first resource, the first reference resource pattern is a resource pattern of the reference signal on a second resource, and the first resource is different from the second resource; or the first reference resource pattern is a predefined or preconfigured pattern; or the first reference resource pattern is the second resource pattern or the third basic pattern.

With reference to the third aspect, in some implementations of the third aspect, that the first reference resource pattern is the resource pattern of the reference signal on the second resource includes any one of the following: The first reference resource pattern is a resource pattern of the reference signal on at least one time domain unit, the first reference resource pattern is a resource pattern of the reference signal on at least one frequency domain unit, the first reference resource pattern is a resource pattern of the reference signal on at least one antenna port, or the first reference resource pattern is a resource pattern of the reference signal on at least one antenna port group.

According to a fourth aspect, a signal transmission method is provided, and the method may be performed by an apparatus. The apparatus may be a device (for example, a terminal device or a network device), or may be a component (for example, a chip, a chip system, or a circuit) of the device.

The method may include: receiving third indication information, where the third indication information indicates a first resource pattern of a reference signal, the first resource pattern of the reference signal includes at least one third basic pattern, and the third indication information indicates a relationship between the third basic pattern and a first reference resource pattern; and receiving or sending the reference signal based on a response to the third indication information.

With reference to the fourth aspect, in some implementations of the fourth aspect, receiving or sending the reference signal based on the response to the third indication information includes: sending acknowledgment information of the third indication information, where the acknowledgment information indicates that the resource pattern of the reference signal is the first resource pattern; and receiving or sending the reference signal based on the first resource pattern.

With reference to the fourth aspect, in some implementations of the fourth aspect, receiving or sending the reference signal based on the response to the third indication information includes: sending first indication information, where the first indication information is used to determine a second resource pattern of the reference signal, the resource pattern of the reference signal includes at least one first basic pattern, and the first indication information indicates a relationship between the first basic pattern and a second reference resource pattern; and receiving or sending the reference signal based on the second resource pattern of the reference signal.

With reference to the fourth aspect, in some implementations of the fourth aspect, the third indication information includes first information, and that the third indication information indicates the relationship between the third basic pattern and the first reference resource pattern includes: The first information indicates whether the third basic pattern is updated relative to the first reference resource pattern.

With reference to the fourth aspect, in some implementations of the fourth aspect, the first information indicates that the third basic pattern is updated relative to the first reference resource pattern, the third indication information further includes second information, and the second information indicates the third basic pattern.

With reference to the fourth aspect, in some implementations of the fourth aspect, the first information indicates that a first parameter in configuration information of the third basic pattern is updated relative to a first parameter in configuration information of the first reference resource pattern, and the second information indicates the first parameter in the configuration information of the third basic pattern.

With reference to the fourth aspect, in some implementations of the fourth aspect, the first reference resource pattern includes at least one second basic pattern, and that the third indication information indicates the relationship between the third basic pattern and the first reference resource pattern includes: The third indication information indicates a relationship between the third basic pattern and the second basic pattern.

With reference to the fourth aspect, in some implementations of the fourth aspect, the configuration information of the third basic pattern includes one or more of the following information: a start position of the third basic pattern, a domain corresponding to the third basic pattern, and a resource that is of the reference signal and that is indicated by the third basic pattern, where the domain corresponding to the third basic pattern is any one of the following: a time domain, a frequency domain, and a space domain.

With reference to the fourth aspect, in some implementations of the fourth aspect, the resource that is of the reference signal and that is indicated by the third basic pattern includes at least one of the following information: a total quantity of resources corresponding to the third basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the third basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

With reference to the fourth aspect, in some implementations of the fourth aspect, the method further includes: sending second indication information, where the second indication information indicates at least one bandwidth resource, and the at least one bandwidth resource is associated with the resource pattern of the reference signal.

With reference to the fourth aspect, in some implementations of the fourth aspect, the at least one bandwidth resource includes a first bandwidth resource and a second bandwidth resource, and a resource pattern of the reference signal on the second bandwidth resource is the same as a resource pattern of the reference signal on the first bandwidth resource; or the third indication information includes the first information, the first information indicates whether the third basic pattern is updated relative to the first reference resource pattern, and first information corresponding to the second bandwidth resource is the same as first information corresponding to the first bandwidth resource; or a relationship between a third basic pattern corresponding to the second bandwidth resource and the first reference resource pattern is the same as a relationship between a third basic pattern corresponding to the first bandwidth resource and the first reference resource pattern.

With reference to the fourth aspect, in some implementations of the fourth aspect, the resource pattern of the reference signal is a resource pattern of the reference signal on a first resource, the first reference resource pattern is a resource pattern of the reference signal on a second resource, and the first resource is different from the second resource; or the first reference resource pattern is a predefined or preconfigured pattern; or the first reference resource pattern is the second resource pattern or the third basic pattern.

With reference to the fourth aspect, in some implementations of the fourth aspect, that the first reference resource pattern is the resource pattern of the reference signal on the second resource includes any one of the following: The first reference resource pattern is a resource pattern of the reference signal on at least one time domain unit, the first reference resource pattern is a resource pattern of the reference signal on at least one frequency domain unit, the first reference resource pattern is a resource pattern of the reference signal on at least one antenna port, or the first reference resource pattern is a resource pattern of the reference signal on at least one antenna port group.

For beneficial effect and possible implementations of the second aspect to the fourth aspect, refer to the related descriptions of the first aspect. Details are not described herein again.

According to a fifth aspect, a communication apparatus is provided. The apparatus is configured to perform the method provided in any one of the first aspect to the fourth aspect. Specifically, the apparatus may include units and/or modules, for example, a processing unit and/or a communication unit configured to perform the method provided in any one of the implementations of any one of the first aspect to the fourth aspect.

In an implementation, the apparatus is a communication device (for example, a terminal device, and for another example, a network device). When the apparatus is a communication device, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in the communication device. When the apparatus is a chip, a chip system, or a circuit used in the communication device, the communication unit may be an input/output interface, an interface circuit, an output circuit, an input circuit, a pin, a related circuit, or the like on the chip, the chip system, or the circuit, and the processing unit may be at least one processor, processing circuit, logic circuit, or the like.

According to a sixth aspect, a communication apparatus is provided. The apparatus includes: a memory configured to store a program; and at least one processor configured to execute a computer program or instructions stored in the memory, to perform the method provided in any one of the implementations of any one of the first aspect to the fourth aspect.

In an implementation, the apparatus is a communication device (for example, a terminal device, and for another example, a network device).

In another implementation, the apparatus is a chip, a chip system, or a circuit used in the communication device.

According to a seventh aspect, this disclosure provides a processor configured to perform the methods provided in the foregoing aspects.

Unless otherwise specified, or if operations such as sending and obtaining/receiving related to the processor do not conflict with actual functions or internal logic of the processor in related descriptions, the operations may be understood as operations such as outputting and inputting performed by the processor, or may be understood as sending and receiving operations performed by a radio frequency circuit and an antenna.

According to an eighth aspect, a computer-readable storage medium is provided. The computer-readable medium stores program code to be executed by a device, and the program code includes the method provided in any one of the implementations of any one of the first aspect to the fourth aspect.

According to a ninth aspect, a computer program product including instructions is provided. When the computer program product runs on a computer, the computer is caused to perform the method provided in any one of the implementations of any one of the first aspect to the fourth aspect.

According to a tenth aspect, a chip is provided. The chip includes a processor and a communication interface. The processor reads, through the communication interface, instructions stored in a memory, to perform the method provided in any one of the implementations of any one of the first aspect to the fourth aspect.

Optionally, in an implementation, the chip further includes the memory. The memory stores a computer program or the instructions. The processor is configured to execute the computer program or the instructions stored in the memory. When the computer program or the instructions are executed, the processor is configured to perform the method provided in any one of the implementations of any one of the first aspect to the fourth aspect.

According to an eleventh aspect, a communication system is provided, including a first communication apparatus and a second communication apparatus. The first communication apparatus is configured to perform the method provided in any one of the implementations of the first aspect, and the second communication apparatus is configured to perform the method provided in any one of the implementations of the second aspect; or the first communication apparatus is configured to perform the method provided in any one of the implementations of the third aspect, and the second communication apparatus is configured to perform the method provided in any one of the implementations of the fourth aspect.

### BRIEF DESCRIPTION OF THE DRAWINGS

FIG. 1 is a diagram of a wireless communication system applicable to an embodiment;

FIG. 2 is a diagram of a signal transmission method 200 according to an embodiment;

FIG. 3 is a diagram of a resource pattern and a basic pattern of a reference signal;

FIG. 4 is a diagram of a preset pattern and a basic pattern;

FIG. 5 is a diagram of a basic pattern;

FIG. 6 is another diagram of a basic pattern;

FIGS. 7A-7C are diagrams of reference resource patterns;

FIG. 8 is a diagram of a reference resource pattern and a basic pattern;

FIG. 9 is a diagram of a preset pattern;

FIG. 10 is a diagram of an association between a bandwidth resource and resource patterns of a reference signal;

FIG. 11 is a diagram of a signal transmission method 1100 according to an embodiment;

FIG. 12 is a schematic flowchart of a signal transmission method 1200 according to an embodiment;

FIG. 13 is a schematic flowchart of a method 1300 according to another embodiment;

FIG. 14 is a schematic flowchart of a method 1400 according to another embodiment;

FIG. 15 is a schematic flowchart of a method 1500 according to another embodiment;

FIG. 16 is a block diagram of a communication apparatus 1600 according to an embodiment;

FIG. 17 is a diagram of another communication apparatus 1700 according to an embodiment; and

FIG. 18 is a diagram of a chip system 1800 according to an embodiment.

### DETAILED DESCRIPTION

The following describes technical solutions with reference to accompanying drawings.

The technical solutions may be applied to various communication systems, for example, a 5G system or a new radio (NR) system, a Long-Term Evolution (LTE) system, an LTE frequency-division duplex (FDD) system, and an LTE time-division duplex (TDD) system. The technical solutions may be further applied to a low-frequency scenario, a high-frequency scenario, terahertz, optical communication, and the like. The technical solutions may be further applied to a future communication system, for example, a 6th generation (6G) mobile communication system. The technical solutions may be further applied to device-to-device (D2D) communication, vehicle-to-everything (V2X) communication, machine-to-machine (M2M) communication, machine-type communication (MTC), or an internet of things (IOT) communication system. The technical solutions may be further applied to a non-terrestrial network (NTN) system, for example, inter-satellite communication and satellite communication. For example, a satellite communication system includes a satellite base station and a terminal device. The satellite base station provides a communication service for the terminal device. The satellite base station may also communicate with a base station. A satellite may be used as a base station, or may be used as a terminal device. The satellite may be an uncrewed aerial vehicle, a hot air balloon, a low-earth orbit satellite, a medium-earth orbit satellite, a high-earth orbit satellite, or the like. Alternatively, the satellite may be a non-terrestrial base station, a non-terrestrial device, or the like.

A device in a communication system may send a signal to another device or receive a signal from another device. The signal may include information, signaling, data, or the like. The device may alternatively be replaced with an entity, a network entity, a network element, a communication device, a communication module, a node, a communication node, or the like. In this disclosure, the device is used as an example for description. For example, the communication system may include at least one terminal device and at least one network device. The network device may send a downlink signal to the terminal device, and/or the terminal device may send an uplink signal to the network device.

The terminal device includes various devices having a wireless communication function, and may be configured to connect a person, an object, a machine, and the like. The terminal device may be widely used in various scenarios, such as cellular communication, D2D, V2X, peer-to-peer (P2P), M2M, MTC, IoT, virtual reality (VR), augmented reality (AR), industrial control, autonomous driving, telemedicine, a smart grid, smart furniture, a smart office, smart wearables, smart transportation, a smart city drone, a robot, remote sensing, passive sensing, positioning, navigation and tracking, and autonomous delivery. The terminal device may be a terminal in any one of the foregoing scenarios, for example, an MTC terminal or an IoT terminal. The terminal device may be a user equipment (UE) in a 3rd Generation Partnership Project (3GPP) standard, a terminal, a fixed device, a mobile station device or a mobile device, a subscriber unit, a handheld device, a vehicle-mounted device, a wearable device, a cellular phone, a smartphone, a Session Initiation Protocol (SIP) phone, a wireless data card, a personal digital assistant (PDA), a computer, a tablet computer, a notebook computer, a wireless modem, a handset, a laptop computer, a computer having a wireless transceiver function, a smart book, a vehicle, a satellite, a Global Positioning System (GPS) device, a target tracking device, an aircraft (for example, an uncrewed aerial vehicle, a helicopter, a multi-helicopter, a four-helicopter, or an airplane), a ship, a remote control device, a smart home device, an industrial device, an apparatus built in the foregoing device (for example, a communication module, a modem, or a chip in the foregoing device), or another processing device connected to a wireless modem. For ease of description, an example in which the terminal device is a terminal or a UE is used below for description.

It should be understood that, in some scenarios, the UE may be further configured to serve as a base station. For example, the UE may act as a scheduling entity that provides a sidelink signal between UEs in scenarios such as V2X, D2D, or P2P.

In embodiments, an apparatus configured to implement a function of the terminal device, that is, a terminal apparatus, may be the terminal device; or may be an apparatus that can support the terminal device in implementing the function, for example, a chip system or a chip, where the apparatus may be installed in the terminal device. In embodiments, the chip system may include a chip, or may include a chip and another discrete device.

The network device may be a device configured to communicate with the terminal device. The network device may also be referred to as an access network device or a radio access network device. For example, the network device may be a base station. The network device may be a radio access network (RAN) node (or device) that connects the terminal device to a wireless network. The base station may cover the following various names in a broad sense, or may be replaced with the following names, for example, a NodeB, an evolved NodeB (eNB), a next-generation NodeB (gNB), a relay station, an access point, a transmitting and receiving point (TRP), a transmitting point, a primary station, a secondary station, a multi-standard radio (MSR) node, a home NodeB, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. The base station may alternatively be a communication module, a modem, or a chip that is disposed in the foregoing device or apparatus. The base station may alternatively be a mobile switching center, a device that bears a base station function in D2D, V2X, and M2M communication, a network side device in a 6G network, a device that bears a base station function in a future communication system, or the like. The base station may support networks of a same access technology or different access technologies. A specific technology and a specific device form that are used by the network device are not limited in embodiments.

The base station may be fixed or mobile. For example, a helicopter or an uncrewed aerial vehicle may be configured as a mobile base station, and one or more cells may move based on a position of the mobile base station. In other examples, the helicopter or the uncrewed aerial vehicle may be configured as a device for communicating with another base station.

In some deployments, the network device may be a device including a CU, a DU, or a CU and a DU, or a device including a control plane CU node (e.g., a CU control plane (CU-CP)), a user plane CU node (e.g., a CU user plane (CU-UP)), and a DU node.

In embodiments, an apparatus configured to implement a function of the network device may be the network device; or may be an apparatus that can support the network device in implementing the function, for example, a chip system or a chip, where the apparatus may be installed in the network device. In embodiments, the chip system may include a chip, or may include a chip and another discrete device.

The network device and the terminal device may be deployed on the land, including an indoor device, an outdoor device, a hand-held device, or a vehicle-mounted device; may be deployed on the water; or may be deployed on an airplane, a balloon, and a satellite in the air. A scenario in which the network device and the terminal device are located is not limited in embodiments.

A communication system applicable to embodiments is first briefly described below.

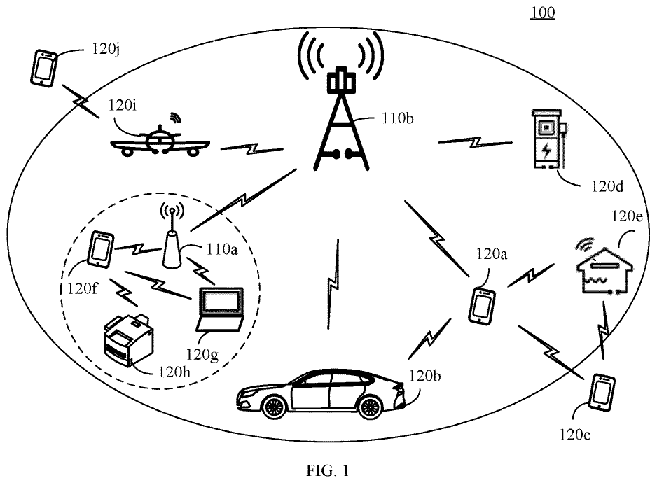

FIG. 1 is a diagram of a wireless communication system applicable to an embodiment.

As shown in FIG. 1, the wireless communication system includes a radio access network 100. The radio access network 100 may be a next generation (for example, 6G or a later version) radio access network, or another (for example, 5G, 4G, 3G, or 2G) radio access network. One or more terminal devices (120a to 120j, collectively referred to as 120) may be connected to each other or to one or more network devices (110a and 110b, collectively referred to as 110) in the radio access network 100. Network elements in the wireless communication system are connected through an interface (for example, NG or Xn) or an air interface.

FIG. 1 is merely a diagram. The wireless communication system may further include another device, for example, may further include a core network device, a wireless relay device, and/or a wireless backhaul device, which are not shown in FIG. 1.

For ease of understanding the technical solutions, some related technologies in the technical solutions are described.

### 1. Reference Signal

The reference signal may also be referred to as a pilot, a reference sequence, a benchmark signal, or the like. For unification, the following uses the reference signal for description. The reference signal is a physical signal that carries a sequence and that is sent for implementing a specific function. Specifically, the reference signal is a physical signal generated by mapping a specific sequence to a corresponding resource in a preset resource mapping manner.

The reference signal (RS) may be any one of the following: a channel state information reference signal (CSI-RS), a sounding reference signal (SRS), a demodulation reference signal (DMRS), a phase tracking reference signal (PT-RS), and a cell reference signal (CRS).

It should be understood that the foregoing enumerated reference signals are merely examples, and should not constitute any limitation on this disclosure. This disclosure does not exclude a possibility of defining another reference signal in a future protocol to implement a same or similar function.

### 2. Resource

Data or information may be carried on the resource.

In time domain, a resource may include one or more time domain units (or may be referred to as time units). A time domain unit may be a symbol, an orthogonal frequency-division multiplexing (OFDM) symbol, a mini-slot, a slot, a partial slot, a subframe, a radio frame, or the like.

In frequency domain, a resource may include one or more frequency domain units. A frequency domain unit may be a resource block (RB), a subcarrier, a resource block group (RBG), a subband, a precoding resource block group (PRG), a bandwidth part (BWP), a carrier, a serving cell, or the like.

In space domain, a resource may include one or more space domain units. A space domain unit may be an antenna port. The antenna port may be referred to as a port for short, and may include a transmit port (or referred to as a send port) and a receive port. Based on different carried signals, the antenna port may be further classified into a reference signal antenna port (or referred to as a reference signal port or a pilot port) and a data antenna port (data port for short).

In a 5G system, reference signals are densely distributed in a frequency direction. In a case of a plurality of antenna ports, reference signals are densely distributed in a frequency direction of each antenna port. With development of communication technologies, there are more antenna ports. If a manner in which the reference signals are densely distributed in the frequency direction of each antenna port is used, a quantity of reference signals is greatly increased, causing an increase in reference signal resource overheads. To reduce reference signal resource overheads, a sparse reference signal pattern may be designed. The sparse reference signal pattern indicates that reference signals are sparsely distributed in one or more of the time domain, the frequency domain, and the space domain. For example, that the reference signals are sparsely distributed in space domain means that the reference signals are sent on a few transmit antenna ports, which is different from the manner in which the reference signals are sent on some consecutive or all antenna ports. For another example, that the reference signals are sparsely distributed in frequency domain means that each reference signal port occupies a small quantity of resources in frequency domain, which is different from the manner in which each reference signal port occupies an even and high-density frequency domain resource in frequency domain. For another example, that the reference signals are sparsely distributed in time domain means that each reference signal port occupies a small quantity of resources in time domain, which is different from the manner in which each reference signal port occupies an even and high-density time domain resource in time domain. In addition, in one manner, arrangements of the reference signals in frequency domain are the same between different antenna ports. Different from that manner, arrangements of the sparse reference signals in frequency domain may be different between different antenna ports. However, using the sparse reference signal pattern causes a sharp increase in indication overheads of the reference signal pattern.

In view of this, this disclosure provides a manner, to indicate a pattern of a reference signal with low overheads.

Before the solutions of are described, the following descriptions are provided.
(1) An “indication” may include a direct indication, an indirect indication, an explicit indication, and an implicit indication. When a piece of indication information is described as indicating A, it may be understood as that the indication information carries A, directly indicates A, or indirectly indicates A.

Information indicated by the indication information is referred to as to-be-indicated information. In a specific implementation process, the to-be-indicated information is indicated in a plurality of manners. For example, the manners include but are not limited to a manner in which the to-be-indicated information, for example, the to-be-indicated information or an index of the to-be-indicated information, may be directly indicated. Alternatively, the to-be-indicated information may be indirectly indicated by indicating other information, and there is an association relationship between the other information and the to-be-indicated information. Alternatively, only a part of the to-be-indicated information may be indicated, and another part of the to-be-indicated information is known or pre-agreed on. For example, specific information may alternatively be indicated by using an arrangement sequence of a plurality of pieces of information that are pre-agreed on (for example, stipulated in a protocol), to reduce indication overheads to some extent. In addition, the to-be-indicated information may be sent as a whole, or may be divided into a plurality of pieces of sub-information to be sent separately, where sending periodicities and/or sending occasions of these pieces of sub-information may be the same or different.
(2) “Sending” and “receiving” indicate signal transmission directions. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY through an air interface from another unit or module. “Sending” may alternatively be understood as “outputting” of a chip interface, and “receiving” may alternatively be understood as “inputting” of the chip interface. In other words, sending and receiving may be performed between devices, for example, between a network device and a terminal device; or may be performed inside a device, for example, sending or receiving between components, modules, chips, software modules, or hardware modules inside the device through a bus, a cable, or an interface.
(3) In embodiments, a “reference signal resource” is mentioned a plurality of times, and represents a resource occupied by a reference signal.
(4) In embodiments, unless otherwise stated or there is a logical conflict, terms and/or descriptions between different embodiments are consistent and may be mutually referenced, and technical features in different embodiments may be combined according to an internal logical relationship thereof, to form a new embodiment.
(5) “First” and “second” are merely for ease of description, and are used to distinguish objects, but are not intended to limit the scope of embodiments, and are not used to describe an order or a sequence of features. It should be understood that objects described in such a way are interchangeable in an appropriate circumstance, so that a solution other than embodiments can be described.

The following describes in detail the method provided in embodiments with reference to the accompanying drawings. Embodiments may be applied to the communication system shown in FIG. 1.

In the following embodiments, a first device and a second device are used as examples for description.

The first device may be a terminal device or a component (for example, a chip or a circuit) of the terminal device, or the first device may be a network device or a component (for example, a chip or a circuit) of the network device, or the first device may be an AI node or a component (for example, a chip or a circuit) of the AI node.

The second device may be a terminal device or a component (for example, a chip or a circuit) of the terminal device, or the second device may be a network device or a component (for example, a chip or a circuit) of the network device, or the second device may be an AI node or a component (for example, a chip or a circuit) of the AI node.

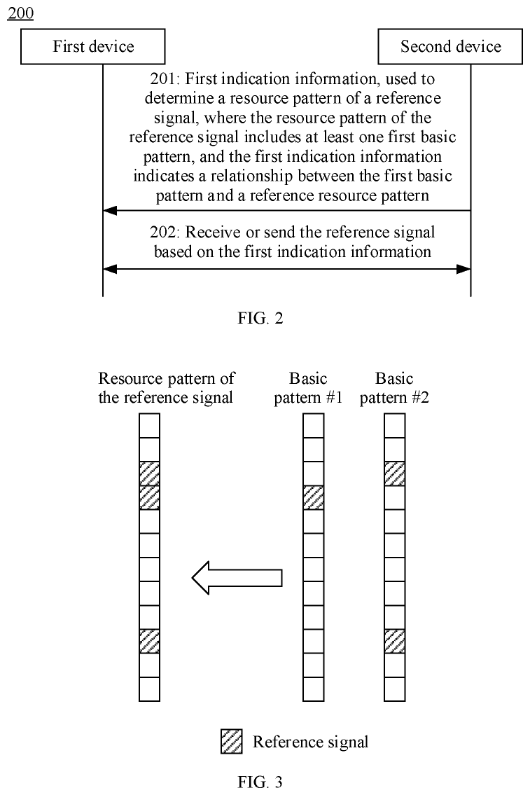

FIG. 2 is a diagram of a signal transmission method 200 according to an embodiment. The method 200 shown in FIG. 2 may include the following steps.
201: A first device receives first indication information, where the first indication information is used to determine a resource pattern of a reference signal, the resource pattern of the reference signal includes at least one first basic pattern, and the first indication information indicates a relationship between the first basic pattern and a reference resource pattern.

Correspondingly, a second device sends the first indication information.

First, concepts are described.
(1) Resource pattern of the reference signal: The resource pattern indicates a pattern of the reference signal, for example, position distribution of the reference signal on a resource unit, and indicates time domain resource position information and/or frequency domain resource position information on the resource unit and information about a mapped antenna port. The resource unit includes at least one resource dimension, for example, a time domain resource dimension, a frequency domain resource dimension, or a space domain resource dimension. Specifically, the resource unit includes, for example, at least one of the following: a time domain unit, a frequency domain unit, an antenna port, or an antenna port group.
(2) Basic pattern: The resource pattern of the reference signal may be formed by combining at least one pattern, and the pattern that forms the resource pattern of the reference signal is referred to as a basic pattern.

FIG. 3 is a diagram of the resource pattern and the basic pattern of the reference signal. As shown in FIG. 3, it is assumed that the resource pattern of the reference signal reflects frequency domain resource position distribution of an antenna port or an antenna port group of the reference signal on a time domain unit (for example, a slot or a symbol in a slot) and a frequency domain unit (for example, a subband). The resource pattern of the reference signal includes two basic patterns, that is, a basic pattern #1 and a basic pattern #2 form the resource pattern of the reference signal.

In this embodiment, for differentiation, the basic pattern in the resource pattern of the reference signal is referred to as the first basic pattern. In other words, the resource pattern of the reference signal includes the at least one first basic pattern. For example, the resource pattern of the reference signal includes two first basic patterns. For another example, the resource pattern of the reference signal includes more than two first basic patterns.
(3) Reference resource pattern: A pattern used for comparison with the resource pattern of the reference signal or a pattern used for comparison with the basic pattern in the resource pattern of the reference signal is referred to as the reference resource pattern (or may be referred to as a reference pattern for short). For example, the resource pattern of the reference signal reflects position distribution of the reference signal on a resource unit #1, and the reference resource pattern reflects position distribution of the reference signal on a resource unit #2. The resource unit #1 is different from the resource unit #2. Specifically, the resource unit #1 and the resource unit #2 have at least one different resource dimension. For another example, the resource pattern of the reference signal reflects position distribution of the reference signal on a resource unit, and the reference resource pattern is preconfigured or predefined.

Optionally, the reference resource pattern includes at least one basic pattern. In this embodiment, for differentiation, the basic pattern in the reference resource pattern is referred to as a second basic pattern, that is, the reference resource pattern includes at least one second basic pattern. Further, that the first indication information indicates the relationship between the first basic pattern and the reference resource pattern may be that the first indication information indicates a relationship between the first basic pattern and the second basic pattern. In other words, the first indication information indicates a relationship between each first basic pattern in the resource pattern of the reference signal and each second basic pattern in the reference resource pattern. A quantity of first basic patterns in the resource pattern of the reference signal may be the same as or different from a quantity of second basic patterns in the reference resource pattern. This is not limited.
(4) Preset pattern: A pattern used to obtain the basic pattern is referred to as a preset pattern.

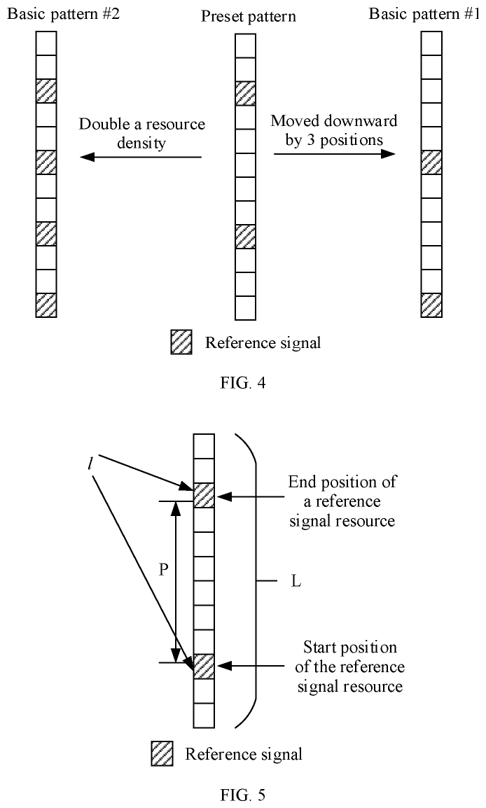

FIG. 4 is a diagram of the preset pattern and the basic pattern. As shown in FIG. 4, for example, the basic pattern #1 is obtained by moving a resource of the reference signal in the preset pattern, for example, moving the resource of the reference signal downward by three positions. For another example, the basic pattern #2 is obtained by adjusting a resource density of a reference signal resource in the preset pattern, for example, doubling the resource density of the reference signal resource. The resource density of the reference signal resource is a quantity of resources between every two reference signal resources plus 1.

The foregoing describes the concepts related to the term “pattern” in embodiments. It may be understood that names of the foregoing terms (for example, the basic pattern and the preset pattern) are used for differentiation, and the names do not limit the protection scope of embodiments.
202: The first device receives or sends the reference signal based on the first indication information.

Specifically, the first indication information is used to determine the resource pattern of the reference signal. In this way, the terminal device can learn of the resource pattern of the reference signal based on the first indication information, and then receive or send the reference signal by using the resource pattern of the reference signal. A solution of the first indication information is described in detail below.

In a possible implementation, the first device receives the reference signal based on the first indication information, and correspondingly, the second device sends the reference signal. For example, it is assumed that the first device is a terminal device, and the second device is a network device. In step 202, the terminal device receives a downlink reference signal (for example, a CSI-RS or a DMRS) based on the first indication information.

In another possible implementation, the first device sends the reference signal based on the first indication information, and correspondingly, the second device receives the reference signal. For example, it is assumed that the first device is a terminal device, and the second device is a network device. In step 202, the terminal device sends an uplink reference signal (for example, an SRS or a DMRS) based on the first indication information.

According to this embodiment, the first indication information used to determine the resource pattern of the reference signal specifically indicates a relationship between each basic pattern forming the resource pattern of the reference signal and the reference resource pattern. The first device can determine each basic pattern based on the relationship and the reference resource pattern, and can further determine the resource pattern of the reference signal based on each basic pattern. Compared with a solution in which the resource pattern of the reference signal is directly indicated, the solution in this embodiment can reduce signaling overheads caused by indicating the resource pattern of the reference signal.

The following describes in detail the solutions in embodiments.

Aspect 1: Related solutions of the basic pattern: The related solutions of the basic pattern that are described below are applicable to the first basic pattern, and are also applicable to the second basic pattern.

Optionally, configuration information of the basic pattern includes at least one of the following: a start position of the basic pattern, a domain corresponding to the basic pattern, and reference signal resource information indicated by the basic pattern. For example, that the first indication information indicates the relationship between the first basic pattern and the reference resource pattern in step 201 indicates that the first indication information indicates a relationship between configuration information of the first basic pattern and configuration information of the second pattern. In this way, the first device can determine the configuration information of the first basic pattern based on the first indication information.

The following separately describes the foregoing three pieces of information.

### 1. Reference Signal Resource Information Indicated by the Basic Pattern

The reference signal resource information indicated by the basic pattern, or the reference signal resource information of the basic pattern for short, may be used to determine a position of a reference signal resource in the basic pattern.

Optionally, the reference signal resource information indicated by the basic pattern includes at least one of the following: a total quantity of resources corresponding to the basic pattern, a total resource quantity of a reference signal resource, a resource density of a reference signal resource, a start position of a reference signal resource, an end position of a reference signal resource, an index of the preset pattern used to obtain the basic pattern, an offset of a reference signal resource relative to the preset pattern, an offset direction of a reference signal resource relative to the preset pattern, and a resource density variation of a reference signal resource relative to the preset pattern.

The following describes the foregoing information with reference to FIG. 4 and FIG. 5.

FIG. 5 is a diagram of the basic pattern.
(1) Total quantity of resources corresponding to the basic pattern: indicating a total quantity of resources included in the basic pattern. As shown in FIG. 5, in the example shown in FIG. 5, the total quantity of resources corresponding to the basic pattern is L (L=12).

The total quantity of resources corresponding to the basic pattern may be a total quantity of time domain resources (for example, a total quantity of time domain units) of the basic pattern in time domain, or may be a total quantity of frequency domain resources (for example, a total quantity of frequency domain units) of the basic pattern in frequency domain, or may be a total quantity of space domain resources (for example, a total quantity of ports) of the basic pattern in space domain. This may specifically depend on whether the domain corresponding to the basic pattern is the time domain, the frequency domain, or the space domain.
(2) Total resource quantity of the reference signal resource: indicating a total quantity of reference signal resources included in the basic pattern, namely, a total quantity of resources occupied by the reference signal. As shown in FIG. 5, in the example shown in FIG. 5, the total resource quantity of the reference signal resource is l (l=2).
(3) Resource density of the reference signal resource: It is assumed that the reference signal resource in the basic pattern is evenly arranged, the resource density of the reference signal resource may be the quantity of resources between every two reference signal resources in the basic pattern plus 1. As shown in FIG. 5, in the example shown in FIG. 5, the resource density of the reference signal resource is P (P=7).
(4) Start position of the reference signal resource: indicating a position of a 1st reference signal resource of the basic pattern in the basic pattern, as shown in FIG. 5.
(5) End position of the reference signal resource: indicating a position of a last reference signal resource of the basic pattern in the basic pattern, as shown in FIG. 5.
(6) Index of the preset pattern: used to identify the preset pattern.

For example, a plurality of preset patterns are predefined, preconfigured, or pre-agreed on, and the basic pattern may be obtained by using one or more preset patterns.

For example, as shown in FIG. 4, the basic pattern #1 may be obtained by using the preset pattern. Specifically, the basic pattern #1 may be obtained by moving the reference signal resource in the preset pattern downward by three resource units.

For another example, as shown in FIG. 4, the basic pattern #2 may be obtained by using the preset pattern. Specifically, the basic pattern #2 may be obtained by doubling the resource density of the reference signal resource in the preset pattern.
(7) Offset of the reference signal resource relative to the preset pattern: indicating an offset of the reference signal resource in the basic pattern relative to the preset pattern, in other words, an offset of the reference signal resource in the basic pattern relative to the reference signal resource in the preset pattern.

For example, as shown in FIG. 4, an offset of the reference signal resource in the basic pattern #1 relative to the preset pattern is 3. In other words, the reference signal resource in the basic pattern #1 is moved downward by three resource units.

For another example, as shown in FIG. 4, an offset of a start position of the reference signal resource in the basic pattern #2 relative to the preset pattern is 3. In other words, the start position of the reference signal resource in the basic pattern #2 is moved downward by three resource units relative to the start position of the reference signal resource in the preset pattern.
(8) Offset direction of the reference signal resource relative to the preset pattern: indicating an offset direction of the reference signal resource in the basic pattern relative to the preset pattern, in other words, an offset direction of the reference signal resource in the basic pattern relative to the reference signal resource in the preset pattern.

For example, as shown in FIG. 4, relative to the preset pattern, an offset direction of the reference signal resource in the basic pattern #1 indicates a downward offset, and an offset direction of the start position of the reference signal resource in the basic pattern #2 indicates a downward offset.

For example, it may be pre-agreed on, predefined, or preconfigured that “−” indicates a downward offset, and “+” indicates an upward offset. In this way, an offset direction may be determined based on “+” and “−”.
(9) Resource density variation of the reference signal resource relative to the preset pattern: indicating a resource density variation of the reference signal resource in the basic pattern relative to the preset pattern, in other words, a resource density variation of the reference signal resource in the basic pattern relative to the reference signal resource in the preset pattern.

For example, as shown in FIG. 4, compared with the preset pattern, the resource density of the reference signal resource in the basic pattern #1 does not change, that is, is 6.

For another example, as shown in FIG. 4, compared with the preset pattern, the resource density variation of the reference signal resource in the basic pattern #2 is doubling. Specifically, the resource density of the reference signal resource in the preset pattern is 6, and the resource density of the reference signal resource in the basic pattern #2 is 3.

The foregoing describes the meaning of the information. The following provides some examples.

Example 1: The reference signal resource information of the basic pattern includes the total resource quantity of the reference signal resource, the resource density of the reference signal resource, and the start position of the reference signal resource.

In this example, the first device can determine the position of the 1^{st} reference signal resource in the basic pattern based on the start position of the reference signal resource, and the first device can determine positions of all the reference signal resources in the basic pattern based on the position of the 1^{st} reference signal resource, the total resource quantity of the reference signal resource, and the resource density of the reference signal resource.

Example 2: The reference signal resource information of the basic pattern includes the total resource quantity of the reference signal resource, the resource density of the reference signal resource, and the end position of the reference signal resource.

In this example, the first device can determine the position of the last reference signal resource in the basic pattern based on the end position of the reference signal resource, and the first device can determine positions of all the reference signal resources in the basic pattern based on the position of the last reference signal resource, the total resource quantity of the reference signal resource, and the resource density of the reference signal resource.

Example 3: The reference signal resource information of the basic pattern includes the total resource quantity of the reference signal resource, the start position of the reference signal resource, and the end position of the reference signal resource.

In this example, the first device can determine the position of the 1st reference signal resource in the basic pattern based on the start position of the reference signal resource, and the first device can determine the position of the last reference signal resource in the basic pattern based on the end position of the reference signal resource. In addition, the first device can determine positions of all the reference signal resources in the basic pattern based on the position of the 1^{st} reference signal resource, the position of the last reference signal resource, and the total resource quantity of the reference signal resource. For example, it may be assumed that the reference signal resource in the basic pattern is evenly arranged (or it is predefined or preconfigured that the reference signal resource in the basic pattern is evenly arranged). The positions of all the reference signal resources in the basic pattern may be determined based on the position of the 1^{st} reference signal resource, the position of the last reference signal resource, and the total resource quantity of the reference signal resource.

Example 4: The reference signal resource information of the basic pattern includes the offset of the reference signal resource relative to the preset pattern and the offset direction of the reference signal resource relative to the preset pattern.

In this example, it is assumed that the preset pattern is predefined, preconfigured, or pre-agreed on in a protocol. In this way, the first device can determine a position of the reference signal resource in the basic pattern based on a position of the reference signal resource in the preset pattern, the offset of the reference signal resource relative to the preset pattern, and the offset direction of the reference signal resource relative to the preset pattern.

Example 5: The reference signal resource information of the basic pattern includes the resource density variation of the reference signal resource relative to the preset pattern.

In this example, it is assumed that the preset pattern is predefined, preconfigured, or pre-agreed on in a protocol. In this way, the first device can determine a position of the reference signal resource in the basic pattern based on a position of the reference signal resource in the preset pattern and the resource density variation of the reference signal resource relative to the preset pattern.

The foregoing briefly enumerates several examples. It may be understood that the reference signal resource information of the basic pattern may include one or more of the foregoing information.

### 2. Domain Corresponding to the Basic Pattern

The domain corresponding to the basic pattern, or referred to as a domain indicated by the basic pattern, may be used to determine a domain in which position distribution of the reference signal is indicated by the basic pattern, or may be used to determine a domain in which resource information of the reference signal is indicated by the basic pattern.

The domain corresponding to the basic pattern is any one of the following: the time domain, the frequency domain, and the space domain. If the domain corresponding to the basic pattern is the time domain, it may be determined that the basic pattern indicates position distribution (or resource information) of the reference signal in time domain. If the domain corresponding to the basic pattern is the frequency domain, it may be determined that the basic pattern indicates position distribution (or resource information) of the reference signal in frequency domain. If the domain corresponding to the basic pattern is the space domain, it may be determined that the basic pattern indicates position distribution (or resource information) of the reference signal in space domain.

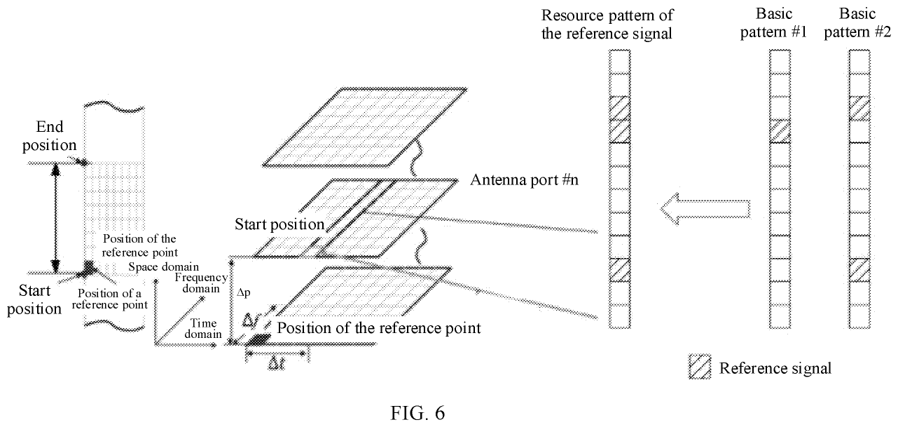

FIG. 6 is another diagram of the basic pattern. As shown in FIG. 6, it is assumed that the domain corresponding to the basic pattern #1 is the frequency domain. In this case, the basic pattern #1 indicates the position distribution (or the resource information) of the reference signal in frequency domain.

In a possible implementation, the domain corresponding to the basic pattern is indicated by one or more bits. For example, 2 bits indicate the domain corresponding to the basic pattern. For example, it is assumed that the 2 bits are set to “00”, indicating that the domain corresponding to the basic pattern is the time domain. For another example, it is assumed that the 2 bits are set to “01”, indicating that the domain corresponding to the basic pattern is the frequency domain. For another example, it is assumed that the 2 bits are set to “10”, indicating that the domain corresponding to the basic pattern is the space domain.

### 3. Start Position of the Basic Pattern

The start position of the basic pattern indicates a start position of the basic pattern in time domain, frequency domain, or space domain. Specifically, if the domain corresponding to the basic pattern is the time domain, the start position of the basic pattern indicates the start position of the basic pattern in time domain. If the domain corresponding to the basic pattern is the frequency domain, the start position of the basic pattern indicates the start position of the basic pattern in frequency domain. If the domain corresponding to the basic pattern is the space domain, the start position of the basic pattern indicates the start position of the basic pattern in space domain.

In a possible implementation, the start position of the basic pattern may be obtained by using a position of a reference point and an offset of a start point relative to the reference point. For example, the start position of the basic pattern in time domain may be obtained by using a position of the reference point in time domain and an offset of the start point relative to the reference point.

For example, as shown in FIG. 6, if the basic pattern corresponds to the position information of the reference signal resource in space domain (namely, an antenna port, for example, an antenna port #n), the start position of the basic pattern is a start position in space domain (namely, the antenna port, for example, the antenna port #n). The start position may be obtained by using the position of the reference point and an offset Δp of the start point relative to the reference point. For another example, as shown in FIG. 6, if the basic pattern corresponds to the position information of the reference signal resource in time domain, the start position of the basic pattern is a start position in time domain. The start position may be obtained by using the position of the reference point and an offset Δt of the start point relative to the reference point. For another example, as shown in FIG. 6, if the basic pattern corresponds to the position information of the reference signal resource in frequency domain, the start position of the basic pattern is a start position in frequency domain. The start position may be obtained by using the position of the reference point and an offset Δf of the start point relative to the reference point.

The foregoing describes the related solutions of the basic pattern, and the following describes related solutions of the reference resource pattern.

Aspect 2: Related solutions of the reference resource pattern

Selection of the reference resource pattern includes the following several implementations.

In a first possible implementation, the reference resource pattern is a pattern of the reference signal on a resource (for example, a time domain unit, a frequency domain unit, or a space domain unit).

Optionally, the resource pattern of the reference signal is a resource pattern of the reference signal on a first resource, the reference resource pattern is a resource pattern of the reference signal on a second resource, and the first resource is different from the second resource. Further, optionally, the first device considers by default (for example, presets or preconfigures) that the reference resource pattern is a resource pattern on the second resource. Alternatively, the second device indicates, to the first device, that the reference resource pattern is a resource pattern on the second resource, for example, by using any one of the following signaling: control signaling (for example, DCI) on a control channel, a medium access control (MAC) control element (CE) radio resource control (RRC). For example, the reference resource pattern and first information may be carried in same signaling.

The resource may be a time domain resource (for example, at least one time domain unit), or may be a frequency domain resource (for example, at least one frequency domain unit), or may be a space domain resource (for example, at least one antenna port or at least one antenna port group).

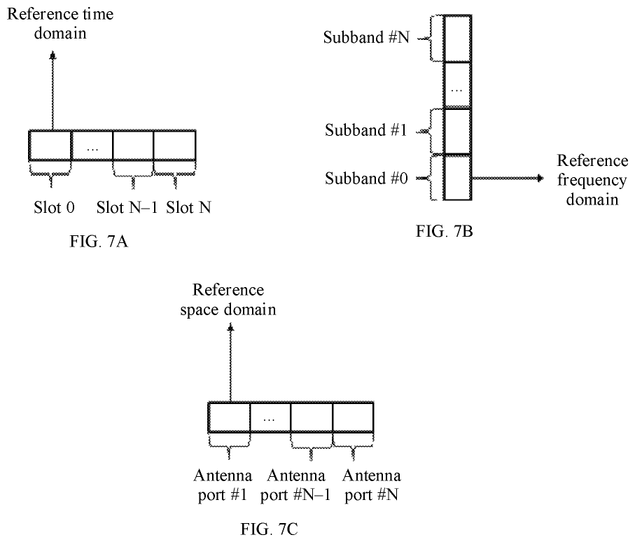

FIGS. 7A-7C are diagrams of reference resource patterns. For example, as shown in FIG. 7A, the reference resource pattern may be a resource pattern of the reference signal in reference time domain, namely, a resource pattern of the reference signal on a time domain unit (for example, a slot 0). For another example, as shown in FIG. 7B, the reference resource pattern may be a resource pattern of the reference signal in reference frequency domain, namely, a resource pattern of the reference signal on a frequency domain unit (for example, a subband #0). For another example, as shown in FIG. 7C, the reference resource pattern may be a resource pattern of the reference signal in reference space domain, namely, a resource pattern of the reference signal on an antenna port (for example, an antenna port #1).

In a second possible implementation, the reference resource pattern is a predefined or preconfigured pattern.

For example, at least one reference resource pattern may be predefined in a protocol.

For another example, the reference resource pattern may be preconfigured by the first device for the second device. For example, the first device preconfigures at least one reference resource pattern for the second device.

Further, optionally, when the second device sends the first indication information to the first device to indicate the relationship between the first basic pattern and the reference resource pattern, the second device may further indicate, to the first device, the reference resource pattern in the first indication information.

In a third possible implementation, the reference resource pattern is a pattern recommended by the first device.

Optionally, before step 201, the method 200 further includes: The first device sends third indication information, where the third indication information indicates a recommended resource pattern (referred to as a pattern #A for differentiation) of the reference signal. If the resource pattern that is of the reference signal and that is configured by the second device is inconsistent with the pattern #A, the second device may send the first indication information to the first device. Further, optionally, the first device considers by default (for example, presets or preconfigures) that the reference resource pattern is the pattern #A; or the second device indicates, to the first device, that the reference resource pattern is the pattern #A.

The foregoing three possible implementations are examples for description, and constitute no limitation herein. Any pattern that can be used for comparison with the first basic pattern is applicable to embodiments.

In addition, as described above, optionally, the reference resource pattern includes the at least one basic pattern (for differentiation, the basic pattern is referred to as the second basic pattern). Further, optionally, that the first indication information indicates the relationship between the first basic pattern and the reference resource pattern may be that the first indication information indicates the relationship between the first basic pattern and the second basic pattern. The following enumerates several possible implementations with reference to several different scenarios.

Scenario 1: The quantity of first basic patterns is the same as the quantity of second basic patterns.

In a possible implementation, the first indication information indicates the relationship between each first basic pattern and each second basic pattern.

For example, the resource pattern of the reference signal includes a first basic pattern #1 and a first basic pattern #2, and the reference resource pattern includes a second basic pattern #1 and a second basic pattern #2. The first indication information indicates a relationship between the first basic pattern #1 and the second basic pattern #1 and a relationship between the first basic pattern #2 and the second basic pattern #2.

In another possible implementation, the first indication information indicates a relationship between each first basic pattern and a part of the second basic patterns.

For example, the resource pattern of the reference signal includes a first basic pattern #1 and a first basic pattern #2, and the reference resource pattern includes a second basic pattern #1 and a second basic pattern #2. The first indication information indicates a relationship between the first basic pattern #1 and the second basic pattern #1 and a relationship between the first basic pattern #2 and the second basic pattern #1.

Scenario 2: The quantity of first basic patterns is greater than the quantity of second basic patterns.

In a possible implementation, the first indication information indicates a relationship between each first basic pattern and a part or all of the second basic patterns.

For example, the resource pattern of the reference signal includes a first basic pattern #1, a first basic pattern #2, and a first basic pattern #3, and the reference resource pattern includes a second basic pattern #1 and a second basic pattern #2. The first indication information indicates a relationship between each basic pattern (namely, the first basic pattern #1, the first basic pattern #2, and the first basic pattern #3) and the second basic pattern #1. Alternatively, the first indication information indicates a relationship between the first basic pattern #1 and the second basic pattern #1, a relationship between the first basic pattern #2 and the second basic pattern #1, and a relationship between the first basic pattern #3 and the second basic pattern #2.

Scenario 3: The quantity of first basic patterns is less than the quantity of second basic patterns.

In a possible implementation, the first indication information indicates a relationship between each first basic pattern and a part of the second basic patterns.

For example, the resource pattern of the reference signal includes a first basic pattern #1 and a first basic pattern #2, and the reference resource pattern includes a second basic pattern #1, a second basic pattern #2, and a second basic pattern #3. The first indication information indicates a relationship between each basic pattern (namely, the first basic pattern #1 and the first basic pattern #2) and the second basic pattern #1. Alternatively, the first indication information indicates a relationship between the first basic pattern #1 and the second basic pattern #1 and a relationship between the first basic pattern #2 and the second basic pattern #2.

The foregoing separately describes the basic pattern and the reference resource pattern. The following describes related solutions of the first indication information.

Aspect 3: Related solutions of the first indication information

Optionally, the first indication information includes the first information, and that the first indication information indicates the relationship between the first basic pattern and the reference resource pattern includes: The first information indicates whether the first basic pattern is updated relative to the reference resource pattern. Further, optionally, the first information indicates that the first basic pattern is updated relative to the reference resource pattern, the first indication information further includes second information, and the second information indicates the first basic pattern.

Based on the foregoing technical solution, the resource pattern of the reference signal can be indicated by two levels of signaling (namely, the first information and the second information). Specifically, first-level signaling (namely, the first information) indicates whether the basic pattern (namely, the first basic pattern) is updated relative to the reference resource pattern. If the basic pattern is updated relative to the reference resource pattern, second-level signaling (namely, the second information) indicates the basic pattern. For example, the configuration information of the basic pattern is indicated. For another example, an updated parameter of the basic pattern relative to the reference resource pattern is indicated. In this manner, signaling overheads caused by indicating the resource pattern of the reference signal can be reduced.

For example, the first indication information is carried in any one of the following signaling: control signaling (for example, DCI) on a control channel, a MAC CE, or RRC. For example, the first indication information may be at a port level, a port group level, a device level, a cell level, or the like. This is not limited.

As described above, in some cases, the first indication information includes the first information and the second information. It may be understood that the first information and the second information are not limited to being transmitted by using one piece of signaling. For example, the first information and the second information may be transmitted by using different signaling. For another example, the first information and the second information may be transmitted by using same signaling, for example, different fields of the same signaling.

Whether the first basic pattern is updated relative to the reference resource pattern may indicate whether the configuration information of the first basic pattern is the same as configuration information of the reference resource pattern.

For example, whether the first basic pattern is updated relative to the reference resource pattern indicates whether the reference signal resource information of the first basic pattern is the same as reference signal resource information of the reference resource pattern. If the reference signal resource information of the first basic pattern is the same as the reference signal resource information of the reference resource pattern, it indicates that the first basic pattern is not updated relative to the reference resource pattern. If the reference signal resource information of the first basic pattern is different from the reference signal resource information of the reference resource pattern (for example, at least one piece of information in the total resource quantity of the reference signal resource, the resource density of the reference signal resource, the start position of the reference signal resource, or the end position of the reference signal resource is different), it indicates that the first basic pattern is updated relative to the reference resource pattern.

The following describes the first information and the second information in detail. For ease of differentiation and description, the following uses signaling #1 to represent the first information, and uses signaling #2 to represent the second information.

### 1. Signaling #1 (Namely, the First Information)

For example, the signaling #1 includes the following several solutions.

Solution A: The signaling #1 indicates whether the first basic pattern is updated compared with the reference resource pattern.

Specifically, the signaling #1 indicates that, compared with the reference resource pattern, the first basic pattern is updated, or the first basic pattern is not updated.

Optionally, the signaling #1 is implemented by using one or more bits. For example, the signaling #1 is implemented by using 1 bit. For example, if a value of the bit is “1”, it indicates that the first basic pattern is not updated relative to the reference resource pattern. If a value of the bit is “0”, it indicates that the first basic pattern is updated relative to the reference resource pattern.

For a case in which there are a plurality of first basic patterns, the following implementations may be included.

In a first possible implementation, one piece of signaling #1 indicates whether the plurality of first basic patterns are updated relative to the reference resource pattern.

For example, the signaling #1 may be implemented by using a plurality of bits.

For example, the signaling #1 may be implemented by using a multi-bit bitmap. It is assumed that the resource pattern of the reference signal includes N first basic patterns, and an N-bit bitmap (namely, the signaling #1) may indicate whether the N first basic patterns are updated relative to the reference resource pattern, where N is an integer greater than 1.

For example, it is assumed that N=5. The five first basic patterns are respectively a first basic pattern #1, a first basic pattern #2, a first basic pattern #3, a first basic pattern #4, and a first basic pattern #5. In addition, it is assumed that a bit value being “1” indicates that no update occurs, and a bit value being “0” indicates that an update occurs. For example, if a value of the 5-bit bitmap is “10010”, it indicates that the first basic pattern #1 and the first basic pattern #4 are not updated relative to the reference resource pattern, and the first basic pattern #2, the first basic pattern #3, and the first basic pattern #5 are updated relative to the reference resource pattern. For another example, if a value of the 5-bit bitmap is “01110”, it indicates that the first basic pattern #1 and the first basic pattern #5 are updated relative to the reference resource pattern, and the first basic pattern #2, the first basic pattern #3, and the first basic pattern #4 are not updated relative to the reference resource pattern. A correspondence between each bit in the bitmap and the first basic pattern may be pre-agreed on, predefined, or preconfigured. This is not limited.

In a second possible implementation, one piece of signaling #1 indicates whether one first basic pattern is updated relative to the reference resource pattern.

For example, it is assumed that there are N first basic patterns. In this case, whether the N first basic patterns are updated relative to the reference resource pattern may be indicated by N pieces of signaling #1.

It may be understood that the foregoing two implementations are examples for description, and constitute no limitation. For example, it is assumed that there are two pieces of signaling #1. One piece of signaling #1 indicates whether a part of the first basic patterns are updated relative to the reference resource pattern, and the other piece of signaling #1 indicates whether the remaining part of the first basic patterns are updated relative to the reference resource pattern. For another example, it is assumed that there are three pieces of signaling #1. One piece of signaling #1 indicates whether a part of the first basic patterns are updated relative to the reference resource pattern, another piece of signaling #1 indicates whether another part of the first basic patterns are updated relative to the reference resource pattern, and the other piece of signaling indicates whether the remaining part of the first basic patterns are updated relative to the reference resource pattern.

Solution B: The signaling #1 indicates whether each parameter of the first basic pattern is updated relative to the reference resource pattern.

Specifically, the signaling #1 indicates that, compared with the reference resource pattern, a parameter of the first basic pattern is not updated, and/or a parameter of the first basic pattern is updated.

For example, the configuration information of the first basic pattern and the configuration information of the reference resource pattern each include configuration information of M parameters, where M is an integer greater than or equal to 1. The signaling #1 may indicate which parameter in the M parameters of the first basic pattern is updated relative to the M parameters of the reference resource pattern.

Optionally, the signaling #1 is implemented by using one or more bits. For example, the signaling #1 is implemented by using an M-bit bitmap. It is assumed that a bit value being “1” indicates that no update occurs, and a bit value being “0” indicates that an update occurs.

For example, it is assumed that M=3, and the three parameters are respectively a parameter #1, a parameter #2, and a parameter #3. In addition, it is assumed that a bit value being “1” indicates that no update occurs, and a bit value being “0” indicates that an update occurs. For example, if a value of the 3-bit bitmap is “100”, it indicates that the parameter #1 in the first basic pattern is not updated relative to the parameter #1 in the reference resource pattern, the parameter #2 in the first basic pattern is updated relative to the parameter #2 in the reference resource pattern, and the parameter #3 in the first basic pattern is updated relative to the parameter #3 in the reference resource pattern. For another example, if a value of the 3-bit bitmap is “110”, it indicates that the parameter #1 in the first basic pattern is not updated relative to the parameter #1 in the reference resource pattern, the parameter #2 in the first basic pattern is not updated relative to the parameter #2 in the reference resource pattern, and the parameter #3 in the first basic pattern is updated relative to the parameter #3 in the reference resource pattern. A correspondence between each bit in the bitmap and each parameter may be pre-agreed on, predefined, or preconfigured. This is not limited.

Similarly, for a case of a plurality of first basic patterns, refer to the implementation in the solution A. Details are not described herein again.

Solution C: The signaling #1 indicates whether the first basic pattern is updated relative to the reference resource pattern, and when an update occurs, indicates which parameter of the first basic pattern is updated relative to the reference resource pattern.

The solution C may be understood as a combination of the solution A and the solution B. For example, in the solution C, the signaling #1 may include two pieces of information, for example, denoted as information #11 and information #12. The information #11 indicates whether the first basic pattern is updated compared with the reference resource pattern, and the information #12 indicates which parameter of the first basic pattern is updated. The information #11 and the information #12 may be carried in same signaling, or may be carried in different signaling. This is not limited.

For the solution C, refer to the descriptions of the solution A and the solution B. Details are not described herein again.

### 2. Signaling #2 (Namely, the Second Information)

For example, the signaling #2 includes the following several solutions.

Solution a: The signaling #2 indicates the configuration information of the first basic pattern.

Specifically, if the signaling #1 indicates that the first basic pattern is updated relative to the reference resource pattern, the configuration information of the first basic pattern is indicated by the signaling #2. Based on this manner, if the first basic pattern is updated relative to the reference resource pattern, the configuration information of the first basic pattern is indicated by the signaling #2. On the contrary, if the first basic pattern is not updated relative to the reference resource pattern, the configuration information of the first basic pattern may not need to be indicated, to reduce signaling overheads. For example, if the first basic pattern is not updated relative to the reference resource pattern, it only needs to be notified that the first basic pattern is the same as the reference resource pattern. In this case, the first device can determine that the reference resource pattern is the first basic pattern.

Solution b: The signaling #2 indicates an updated parameter in the configuration information of the first basic pattern.

Specifically, if the signaling #1 indicates that one or more parameters (referred to as a first parameter for differentiation) in the first basic pattern are updated relative to the reference resource pattern, the first parameter in the configuration information of the first basic pattern may be indicated by the signaling #2. Based on this manner, if one or more parameters in the configuration information of the first basic pattern are updated relative to the reference resource pattern, the one or more parameters in the configuration information of the first basic pattern are indicated by the signaling #2, and another parameter that is not updated may not be indicated, to reduce signaling overheads.

For example, the configuration information of the first basic pattern and the configuration information of the reference resource pattern each include a parameter #1, a parameter #2, and a parameter #3, and the parameter #1 in the configuration information of the first basic pattern is updated relative to the parameter #1 in the configuration information of the reference resource pattern. If other parameters (namely, the parameter #2 and the parameter #3) are not updated, the signaling #2 only needs to indicate the parameter #1 in the configuration information of the first basic pattern, and does not need to indicate the parameter #2 and the parameter #3.

The foregoing separately describes the signaling #1 and the signaling #2. For ease of understanding, the following provides several specific examples.

In the following examples, it is assumed that the resource pattern of the reference signal is a pattern of the reference signal in a slot j, and the resource pattern of the reference signal includes two first basic patterns, which are respectively referred to as a first basic pattern #1 and a first basic pattern #2. In other words, the resource pattern of the reference signal is obtained by combining the first basic pattern #1 and the first basic pattern #2. The reference resource pattern is a pattern of the reference signal in a slot i, and the reference resource pattern includes two second basic patterns, which are respectively referred to as a second basic pattern #1 and a second basic pattern #2. In other words, the reference resource pattern is obtained by combining the second basic pattern #1 and the second basic pattern #2. Herein, i and j are integers greater than or equal to 0, and i and j are different. For example, j is greater than i (for example, i=0, and j=1). The first indication information indicates the relationship between the first basic pattern and the second basic pattern.

### Example 1

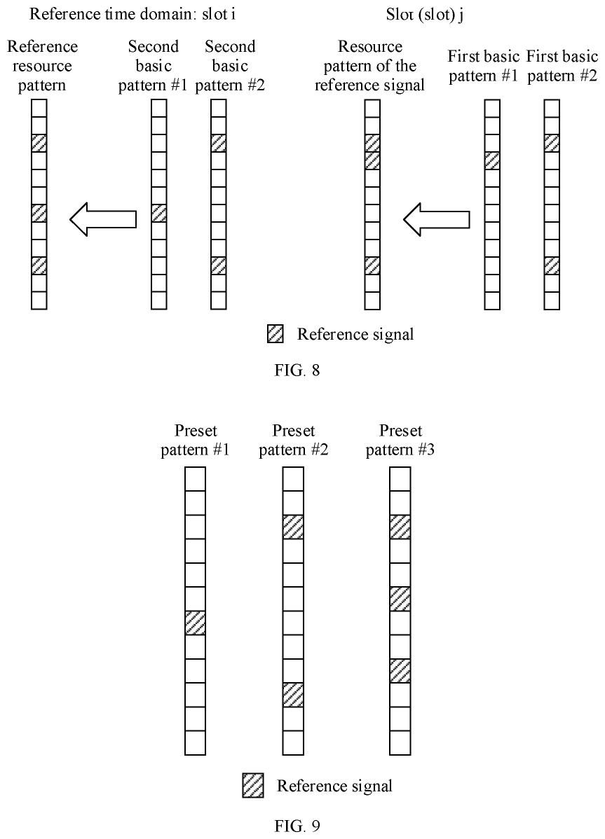

FIG. 8 is a diagram of the reference resource pattern and the basic pattern. As shown in FIG. 8, it is assumed that for each basic pattern (for example, the first basic pattern or the second basic pattern), the reference signal resource information of the basic pattern includes: the total quantity of resource corresponding to the basic pattern, the total resource quantity of the reference signal resource, the resource density of the reference signal resource, and the start position of the reference signal resource. For example, the configuration information of the reference resource pattern is shown in Table 1.

TABLE 1

| | Configuration information of the reference resource pattern |
|---|---|
| | (namely, the pattern of the reference signal in the slot i) |
| Second | (1) Start positions (Δt₁, Δf₁, Δp₁) of the second basic pattern #1; |
| basic | (2) a domain indicated by the second basic pattern #1 is the |
| pattern | frequency domain; |
| #1 | (3) a total quantity of resources corresponding to the second |
| | basic pattern #1 is 12; |
| | (4) a total resource quantity of a reference signal resource is 1; |
| | (5) a resource density of a reference signal resource is 0; and |
| | (6) a start position of a reference signal resource is 6. |
| Second | (1) Start positions (Δt₁, Δf₁, Δp₁) of the second basic pattern #2; |
| basic | (2) a domain indicated by the second basic pattern #2 is the |
| pattern | frequency domain; |
| #2 | (3) a total quantity of resources corresponding to the second |
| | basic pattern #2 is 12; |
| | (4) a total resource quantity of a reference signal resource is 2; |
| | (5) a resource density of a reference signal resource is 7; and |
| | (6) a start position of a reference signal resource is 3. |

It can be learned from FIG. 8 that the resource pattern of the reference signal (namely, the pattern of the reference signal in the slot j) is different from the reference resource pattern (namely, the pattern of the reference signal in the slot i). In other words, the resource pattern of the reference signal is updated relative to the reference resource pattern. Specifically, the first basic pattern #1 is different from the second basic pattern #1, and the first basic pattern #2 is the same as the second basic pattern #2. In other words, the first basic pattern #1 in the resource pattern of the reference signal is updated compared with the second basic pattern #1 in the reference resource pattern. Therefore, the first basic pattern #1 needs to be indicated.

In a first possible implementation, the solution C is used for the signaling #1, the solution b is used for the signaling #2, and it is assumed that a bit value being “1” indicates that no update occurs, and a bit value being “0” indicates that an update occurs. Content of the signaling #1 and the signaling #2 is shown in Table 2.

TABLE 2
First-level signaling (namely, the signaling #1)

| | | |
|---|---|---|
| Information #11 | 0 1 | The first basic pattern #1 is updated, and the first basic |
| | | pattern #2 is not updated. |
| Information #12 | 1 1 1 1 1 0 | (1) A start position of the first basic pattern #1: not updated; |
| | | (2) a domain indicated by the first basic pattern #1: not |
| | | updated; |
| | | (3) a total quantity of resources corresponding to the first |
| | | basic pattern #1: not updated; |
| | | (4) a total resource quantity of a reference signal resource: |
| | | not updated; |
| | | (5) a resource density of a reference signal resource: not |
| | | updated; and |
| | | (6) a start position of a reference signal resource: updated. |

Second-level signaling (namely, the signaling #2)

| | |
|---|---|
| Signaling #2 | A start position of a reference signal resource is 9. |

Table 2 is used as an example. Specifically, it can be learned from the signaling #1 that the first basic pattern #1 is updated, that is, the first basic pattern is updated relative to the second basic pattern #1, and the following parameter, namely, the start position of the reference signal resource, is specifically updated. Therefore, the updated parameter may be indicated by the signaling #2. In other words, the start position of the reference signal resource in the first basic pattern #1 is indicated by the signaling #2.

Table 2 is an example for description, and constitutes no limitation. For example, the first-level signaling may further include information (for example, denoted as information #13). The information #13 indicates a time domain resource on which the reference resource pattern is located. For example, the information #13 indicates the slot i.

In a second possible implementation, the solution A is used for the signaling #1, the solution a is used for the signaling #2, and it is assumed that a bit value being “1” indicates that no update occurs, and a bit value being “0” indicates that an update occurs. Content of the signaling #1 and the signaling #2 is shown in Table 3.

TABLE 3
First-level signaling (namely, the signaling #1)

| | | |
|---|---|---|
| Signaling #1 | 0 1 | The first basic pattern #1 is updated, and |
| | | the first basic pattern #2 is not updated. |

Second-level signaling (namely, the signaling #2)

| | |
|---|---|
| Signaling #2 | (1) Start positions (Δt₁, Δf₁, Δp₁) of the first basic pattern #1; |
| | (2) a domain indicated by the first basic pattern #1 is the frequency domain; |
| | (3) a total quantity of resources corresponding to the first basic pattern #1 |
| | is 12; |
| | (4) a total resource quantity of a reference signal resource is 2; |
| | (5) a resource density of a reference signal resource is 7; and |
| | (6) a start position of a reference signal resource is 9. |

Table 3 is used as an example. Specifically, it can be learned from the signaling #1 that the first basic pattern #1 is updated, that is, the first basic pattern is updated relative to the second basic pattern #1. Therefore, the configuration information of the first basic pattern #1 may be indicated by the signaling #2.

Table 3 is an example for description, and constitutes no limitation. For example, the first-level signaling may further include information (for example, denoted as information #13). The information #13 indicates a time domain resource on which the reference resource pattern is located. For example, the information #13 indicates the slot i.

### Example 2

In this example, it may be assumed that the basic pattern (namely, the first basic pattern and the second basic pattern) is obtained by using at least one preset pattern.

FIG. 9 is a diagram of the preset pattern. As shown in FIG. 9, three preset patterns may be predefined, preconfigured, or preset, for example, respectively denoted as a preset pattern #1, a preset pattern #2, and a preset pattern #3. The first basic pattern and the second basic pattern each may be obtained by using the one or more preset patterns.

It is assumed that for each basic pattern (namely, the first basic pattern and the second basic pattern), one basic pattern is obtained based on one preset pattern. The reference signal resource information of the basic pattern includes: the total quantity of resources corresponding to the basic pattern, the index of the preset pattern used to obtain the basic pattern, the offset of the reference signal resource relative to the preset pattern, the offset direction of the reference signal resource relative to the preset pattern, and the resource density variation of the reference signal resource relative to the preset pattern. For example, the configuration information of the reference resource pattern is shown in Table 4.

TABLE 4

| | Configuration information of the reference resource pattern (namely, the |
|---|---|
| | pattern of the reference signal in the slot i) |
| Second basic | (1) Start positions (Δt₁, Δf₁, Δp₁) of the second basic pattern #1; |
| pattern #1 | (2) a domain indicated by the second basic pattern #1 is the frequency domain; |
| | (3) a total quantity of resources corresponding to the second basic pattern #1 |
| | is 12; |
| | (4) an index of a preset pattern (for example, denoted as a preset pattern #1) |
| | used to obtain the second basic pattern #1 is 1; |
| | (5) an offset and an offset direction of a reference signal resource relative to |
| | the preset pattern #1 are 0; and |
| | (6) a resource density variation of a reference signal resource relative to the |
| | preset pattern #1 is 1. |
| Second basic | (1) Start positions (Δt₁, Δf₁, Δp₁) of the second basic pattern #2; |
| pattern #2 | (2) a domain indicated by the second basic pattern #2 is the frequency domain; |
| | (3) a total quantity of resources corresponding to the second basic pattern #2 |
| | is 12; |
| | (4) an index of a preset pattern (for example, denoted as a preset pattern #2) |
| | used to obtain the second basic pattern #2 is 2; |
| | (5) an offset and an offset direction of a reference signal resource relative to |
| | the preset pattern #2 are 0; and |
| | (6) a resource density variation of a reference signal resource relative to the |
| | preset pattern #2 is 1. |

If the resource density variation is 1, it indicates that the resource density does not change. In other words, the resource density variation of the preset pattern is the same as that of the basic pattern obtained based on the preset pattern.

It can be learned from FIG. 8 that the resource pattern of the reference signal (namely, the pattern of the reference signal in the slot j) is different from the reference resource pattern (namely, the pattern of the reference signal in the slot i). In other words, the resource pattern of the reference signal is updated relative to the reference resource pattern. Specifically, the first basic pattern #1 is different from the second basic pattern #1, and the first basic pattern #2 is the same as the second basic pattern #2. In other words, the first basic pattern #1 in the resource pattern of the reference signal is updated compared with the second basic pattern #1 in the reference resource pattern. Therefore, the first basic pattern #1 needs to be indicated.

In a first possible implementation, the solution C is used for the signaling #1, the solution b is used for the signaling #2, and it is assumed that a bit value being “1” indicates that no update occurs, and a bit value being “0” indicates that an update occurs. Content of the signaling #1 and the signaling #2 is shown in Table 5.

TABLE 5
First-level signaling (namely, the signaling #1)

| | | |
|---|---|---|
| Information #11 | 0 1 | The first basic pattern #1 is updated, and the first basic |
| | | pattern #2 is not updated. |
| Information #12 | 1 1 1 1 0 1 | (1) A start position of the first basic pattern #1: not updated; |
| | | (2) a domain indicated by the first basic pattern #1: not |
| | | updated; |
| | | (3) a total quantity of resources corresponding to the first |
| | | basic pattern #1: not updated; |
| | | (4) an index of a preset pattern used to obtain the first basic |
| | | pattern #1: not updated; |
| | | (5) an offset and an offset direction of a reference signal |
| | | resource relative to the preset pattern: updated; and |
| | | (6) a resource density variation of a reference signal |
| | | resource relative to the preset pattern: not updated. |

Second-level signaling (namely, the signaling #2)

| | |
|---|---|
| Signaling #2 | An offset and an offset direction of a reference signal resource |
| | relative to the preset pattern: +3 |

Table 5 is used as an example. Specifically, it can be learned from the signaling #1 that the first basic pattern #1 is updated, that is, the first basic pattern is updated relative to the second basic pattern #1. Specifically, the preset pattern used to obtain the first basic pattern #1 and the preset pattern used to obtain the second basic pattern #1 are the same, that is, both are the preset pattern #1. The offset and the offset direction of the reference signal resource in the first basic pattern #1 relative to the preset pattern #1 are different from the offset and the offset direction of the reference signal resource in the second basic pattern #1 relative to the preset pattern #1. In other words, the offset and the offset direction of the reference signal resource in the first basic pattern #1 are updated relative to the second basic pattern #1. Therefore, the offset and the offset direction of the reference signal resource in the first basic pattern #1 relative to the preset pattern #1 may be indicated by the signaling #2. It is assumed that “+” indicates an upward offset, and “−” indicates a downward offset. The offset and the offset direction of the reference signal resource in the first basic pattern #1 relative to the preset pattern #1 are +3.

Table 5 is an example for description, and constitutes no limitation. For example, the first-level signaling may further include information (for example, denoted as information #13). The information #13 indicates a time domain resource on which the reference resource pattern is located. For example, the information #13 indicates the slot i.

In a second possible implementation, the solution A is used for the signaling #1, the solution a is used for the signaling #2, and it is assumed that a bit value being “1” indicates that no update occurs, and a bit value being “0” indicates that an update occurs. Content of the signaling #1 and the signaling #2 is shown in Table 6.

TABLE 6
First-level signaling (namely, the signaling #1)

| | | |
|---|---|---|
| Signaling #1 | 0 1 | The first basic pattern #1 is updated, and |
| | | the first basic pattern #2 is not updated. |

Second-level signaling (namely, the signaling #2)

| | |
|---|---|
| Signaling #2 | (1) Start positions (Δt₁, Δf₁, Δp₁) of the first basic pattern #1; |
| | (2) a domain indicated by the first basic pattern #1 is the frequency domain; |
| | (3) a total quantity of resources corresponding to the first basic pattern #1 |
| | is 12; |
| | (4) an index of a preset pattern (for example, denoted as a preset pattern #1) |
| | used to obtain the first basic pattern #1 is 1; |
| | (5) an offset and an offset direction of a reference signal resource relative to |
| | the preset pattern #1 are +3; and |
| | (6) a resource density variation of a reference signal resource relative to the |
| | preset pattern #1 is 1. |

Table 6 is used as an example. Specifically, it can be learned from the signaling #1 that the first basic pattern #1 is updated, that is, the first basic pattern is updated relative to the second basic pattern #1. Therefore, the configuration information of the first basic pattern #1 may be indicated by the signaling #2.

Table 6 is an example for description, and constitutes no limitation. For example, the first-level signaling may further include information (for example, denoted as information #13). The information #13 indicates a time domain resource on which the reference resource pattern is located. For example, the information #13 indicates the slot i.

It may be understood that, in Example 1 and Example 2, an example in which an offset (namely, Δt₁, Δf₁, and Δp₁) of the start point relative to the reference point indicates the start position of the basic pattern is mainly used for description. Embodiment are not limited thereto. Any solution in which the start position of the basic pattern can be identified is applicable to embodiments. For example, an index (or an identifier) of the start point indicates the start position of the basic pattern. For example, the start position of the basic pattern may alternatively be represented as (T₁, F₁, P₁), where T₁ indicates a start point of the basic pattern in time domain, F₁ indicates a start point of the basic pattern in frequency domain, and P₁ indicates a start point of the basic pattern in space domain.

The foregoing describes the related solutions of the first indication information.

Optionally, the method 200 further includes: The first device receives second indication information, where the second indication information indicates at least one bandwidth resource, and the at least one bandwidth resource is associated with the resource pattern of the reference signal.

That the at least one bandwidth resource is associated with the resource pattern of the reference signal may indicate that the resource pattern of the reference signal may be used on the at least one bandwidth resource, or the resource pattern of the reference signal indicates position distribution of the reference signal on the at least one bandwidth resource.

For example, the at least one bandwidth resource is a group of bandwidth resources in a BWP, one bandwidth resource is a part of bandwidth resources in one BWP, and one bandwidth resource may also be referred to as a sub-BWP or a unit BWP. A resource of one BWP may include the at least one bandwidth resource. Based on this, if one BWP is divided into the at least one bandwidth resource, the resource pattern of the reference signal associated with the at least one bandwidth resource may be used to learn of a resource pattern of the reference signal on the BWP.

For example, a quantity of bandwidth resources included in the BWP satisfies Formula 1. A quantity of the at least one bandwidth resource (namely, a quantity of bandwidth resources associated with the resource pattern of the reference signal) is less than or equal to the quantity of bandwidth resources included in the BWP.

$${N}_{UnitBWP} = ⌈ ( {N}_{BWP , i}^{size} + ( {N}_{BWP , i}^{start} mod P ) ) / P ⌉ \qquad Formula 1$$

N_{UnitBWP} indicates the quantity of bandwidth resources included in the BWP;

$${N}_{BWP , i}^{size}$$

indicates a size of an i^{th} BWP configured for the first device, and may be indicated by a frequency domain resource (for example, a quantity of RBs) included in the bandwidth resource;

$${N}_{BWP , i}^{start}$$

indicates a number of a start frequency domain resource (for example, a start RB) of the i^{th} BWP configured for the first device; mod indicates a modulo operation; ┌ ┐ indicates rounding up; and P indicates a size of one bandwidth resource, and may be indicated by a frequency domain resource (for example, a quantity of RBs) included in the bandwidth resource, where P is an integer greater than or equal to 1. In the N_{UnitBWP} bandwidth resources, a size of a 1^{st} bandwidth resource and a size of a last bandwidth resource are affected by a start position and an end position of the BWP. Therefore, the size of the 1^{st} bandwidth resource and the size of the last bandwidth resource may not be P. A size of a bandwidth resource between the 1^{st} bandwidth resource and the last bandwidth resource is P.

For example, a size of a 1^{st} bandwidth resource in an i bandwidth resources may satisfy Formula 2.

$${UnitBWP}_{0}^{size} = P - {N}_{BWP , i}^{start} mod P \qquad Formula 2$$

$${UnitBWP}_{0}^{size}$$

indicates the size of the 1^{st} bandwidth resource.

For example, when

$$( {N}_{BWP , i}^{start} + {N}_{BWP , i}^{size} ) mod P > 0 ,$$

the size of the last bandwidth resource satisfies Formula 3.

$${UnitBWP}_{last}^{size} = \frac{{N}_{BWP , i}^{start} + {N}_{BWP , i}^{size}}{P} \qquad Formula 3$$

$${UnitBWP}_{last}^{size}$$

indicates the size of the last bandwidth resource.

In addition, when

$$( {N}_{BWP , i}^{start} + {N}_{BWP , i}^{size} ) mod P = 0 ,$$

the size of the last bandwidth resource is also P.

The foregoing descriptions of the bandwidth resource is an example for description, and constitutes no limitation.

The following uses two bandwidth resources (that is, the at least one bandwidth resource includes a first bandwidth resource and a second bandwidth resource) as an example to describe a case in which the two bandwidth resources are associated with the resource pattern of the reference signal.

Optionally, that the two bandwidth resources are associated with the resource pattern of the reference signal may indicate that the resource pattern of the reference signal may be used on the first bandwidth resource, or may be used on the second bandwidth resource; or may indicate that first information corresponding to the second bandwidth resource is the same as first information corresponding to the first bandwidth resource; or may indicate that a relationship between a first basic pattern corresponding to the second bandwidth resource and the reference resource pattern is the same as a relationship between a first basic pattern corresponding to the first bandwidth resource and the reference resource pattern.

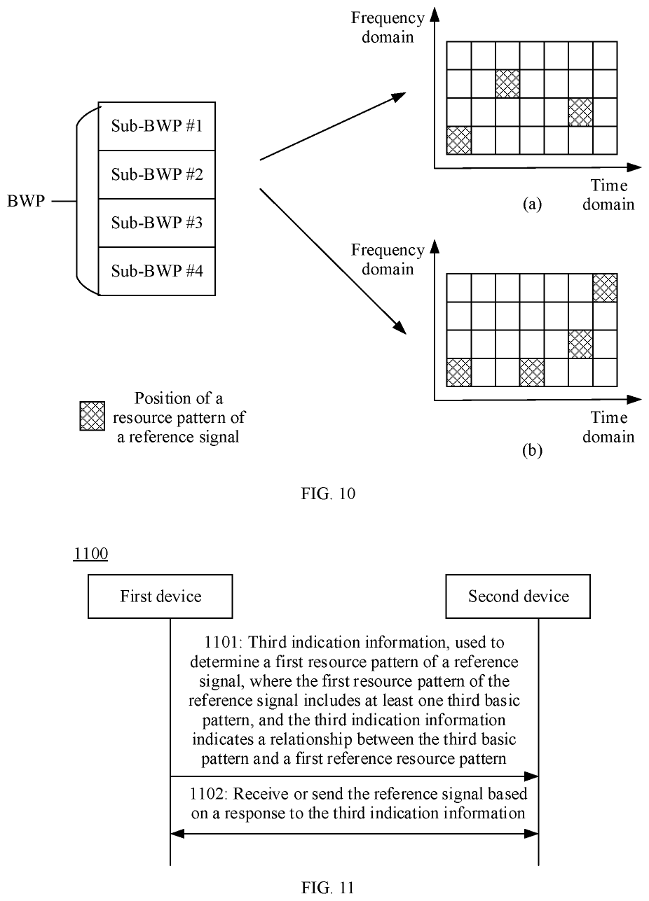

FIG. 10 is a diagram of an association between the bandwidth resource and the resource pattern of the reference signal. As shown in FIG. 10, it is assumed that resources of the BWP are divided into a sub-BWP #1, a sub-BWP #2, a sub-BWP #3, and a sub-BWP #4.

In a possible case, as shown in (a) in FIG. 10, it is assumed that resource patterns of the reference signal in the sub-BWP #3 and the sub-BWP #4 are the same, and the second device may send three pieces of first indication information to the first device, for example, first indication information #1, first indication information #2, and first indication information #3. The first indication information #1 is used to determine a resource pattern of the reference signal in the sub-BWP #1, the first indication information #2 is used to determine a resource pattern of the reference signal in the sub-BWP #2, and the first indication information #3 is used to determine the resource patterns of the reference signal in the sub-BWP #3 and the sub-BWP #4. In other words, the resource patterns of the reference signal in the sub-BWP #3 and the sub-BWP #4 may correspond to one piece of first indication information (namely, the first indication information #3). In other words, a resource pattern that is of the reference signal and that is determined by using the first indication information is the resource patterns of the reference signal in the sub-BWP #3 and the sub-BWP #4. Alternatively, the resource patterns of the reference signal in the sub-BWP #3 and the sub-BWP #4 may correspond to one piece of first information. In other words, whether the first basic pattern is updated relative to the reference resource pattern that is indicated by the first information is applicable to the sub-BWP #3 and the sub-BWP #4.

In another possible case, as shown in (b) in FIG. 10, it is assumed that resource patterns of the reference signal in the sub-BWP #3 and the sub-BWP #4 are different, and the second device may send four pieces of first indication information to the first device, for example, first indication information #1, first indication information #2, first indication information #3, and first indication information #4. The first indication information #1 is used to determine a resource pattern of the reference signal in the sub-BWP #1, the first indication information #2 is used to determine a resource pattern of the reference signal in the sub-BWP #2, the first indication information #3 is used to determine a resource pattern of the reference signal in the sub-BWP #3, and the first indication information #4 is used to determine a resource pattern of the reference signal in the sub-BWP #4.

It may be understood that the first device may determine, based on the first indication information corresponding to the sub-BWP #1, the first indication information corresponding to the sub-BWP #2, the first indication information corresponding to the sub-BWP #3, and the first indication information corresponding to the sub-BWP #4, first indication information corresponding to the BWP. For ease of description, if the first indication information is used to determine the resource pattern of the reference signal on the BWP, the first indication information is referred to as the first indication information corresponding to the BWP.

The foregoing descriptions are example descriptions, and constitute no limitation. For example, when the resource patterns of the reference signal in the sub-BWP #3 and the sub-BWP #4 are the same, the resource patterns may alternatively be separately indicated by using two pieces of first indication information. In addition, the foregoing mainly uses a frequency domain resource as an example for description. This is not limited. For a time domain resource or a space domain resource, refer to the foregoing manner. Details are not described herein again.

As described above, the first device may alternatively recommend the resource pattern of the reference signal to the second device. The following describes this solution in detail with reference to FIG. 11. It may be understood that a method 1100 described below and the method 200 may be used in combination, or may be used separately. This is not limited.

FIG. 11 is a diagram of a signal transmission method 1100 according to an embodiment. The method 1100 shown in FIG. 11 may include the following steps.
1101: A first device sends third indication information, where the third indication information is used to determine a first resource pattern of a reference signal, the first resource pattern of the reference signal includes at least one third basic pattern, and the third indication information indicates a relationship between the third basic pattern and a first reference resource pattern.

Correspondingly, the second device receives the third indication information.

For example, the first device may obtain a communication environment and channel information through sensing, to determine a resource pattern of the reference signal, or may determine a resource pattern of the reference signal based on historical channel information and a communication status, and indicate the resource pattern to a second device.

In this embodiment, for differentiation, a resource pattern that is of the reference signal and that is recommended (or suggested or expected) by the first device is denoted as the first resource pattern of the reference signal, and a resource pattern that is of the reference signal and that is indicated by the second device to the first device is denoted as a second resource pattern of the reference signal.

For a specific implementation of the third indication information, refer to the specific implementation of the first indication information in the method 200. Details are not described herein again.

In this embodiment, for differentiation, a basic pattern in the first resource pattern of the reference signal is referred to as a third basic pattern, and a reference resource pattern used to be compared with the third basic pattern is referred to as the first reference resource pattern. For the third basic pattern, refer to the related descriptions of the first basic pattern in the method 200. For the first reference resource pattern, refer to the related descriptions of the reference resource pattern in the method 200. Details are not described herein again.
1102: The first device receives or sends the reference signal based on a response to the third indication information.

For receiving or sending the reference signal by the first device, refer to the related descriptions in step 202. Details are not described herein again.

The following provides descriptions with reference to two scenarios.

Scenario 1: The second resource pattern of the reference signal is the same as the first resource pattern of the reference signal.

This scenario may include the following several implementations.

In a possible implementation, if the second device determines that the second resource pattern of the reference signal is the same as the first resource pattern of the reference signal, the second device sends acknowledgment information to the first device, where the acknowledgment information is used to notify the first device that the second device agrees with the resource pattern recommended by the first device. In other words, the resource pattern of the reference signal is the first resource pattern. In an example, the acknowledgment information may be implemented by using at least one bit. For example, the acknowledgment information is implemented by using 1 bit. If the bit is set to “0”, it indicates that the second device agrees with the resource pattern recommended by the first device. If the bit is set to “1”, it indicates that the second device disagrees with the resource pattern recommended by the first device.

Based on this implementation, in step 1102, receiving or sending the reference signal based on the response to the third indication information includes: The first device receives or sends the reference signal by using the first resource pattern of the reference signal based on the notification information.

In another possible implementation, if the second device determines that the second resource pattern of the reference signal is the same as the first resource pattern of the reference signal, the second device does not send information to the first device. Correspondingly, if the first device does not receive information (for example, rejection information) from the second device within a period of time (for example, denoted as a time period #1), the first device considers by default that the second device agrees with the resource pattern recommended by the first device. In other words, the resource pattern of the reference signal is the first resource pattern. A start moment of the time period #1 may be a moment at which the first device sends the third indication information, and duration of the time period #1 may be predefined, preconfigured, or pre-agreed on. For example, the time period #1 may alternatively be implemented by using a timer. For example, after sending the third indication information, the first device starts the timer, and running duration of the timer is the duration of the time period #1. Specifically, if the first device receives no message from the second device during running of the timer, the resource pattern of the reference signal is the first resource pattern by default. If the first device receives a message from the second device during running of the timer, the pattern of the reference signal is not the first resource pattern by default.

Based on this implementation, in step 1102, receiving or sending the reference signal based on the response to the third indication information includes: If the first device receives no message from the second device, the first device receives or sends the reference signal by using the first resource pattern of the reference signal.

Scenario 2: The second resource pattern of the reference signal is different from the first resource pattern of the reference signal.

This scenario may include the following several implementations.

In a possible implementation, the method 1100 further includes: The second device may send first indication information to the first device, where the first indication information is used to determine the resource pattern (namely, the second resource pattern) of the reference signal, the second resource pattern includes at least one first basic pattern, the first indication information indicates a relationship between the first basic pattern and a second reference resource pattern, and the second reference resource pattern is the first resource pattern of the reference signal or at least one third basic pattern. In this embodiment, for differentiation, a reference resource pattern used for comparison with the first basic pattern is referred to as the second reference resource pattern.

For example, the second device adjusts the first resource pattern to obtain the second resource pattern. Therefore, the second device may send the first indication information to the first device, where the first indication information indicates a relationship between the first basic pattern and the first resource pattern or the third basic pattern. In this way, the first device may determine the first basic pattern based on the first resource pattern and the relationship, and further determine the second resource pattern. For the method, refer to the descriptions in the method 200. Details are not described herein again.

Based on this implementation, in step 1102, receiving or sending the reference signal based on the response to the third indication information includes: The first device receives or sends the reference signal based on the first indication information.

In another possible implementation, the method 1100 further includes: The second device may send first indication information to the first device, where the first indication information is used to determine the resource pattern (namely, the second resource pattern) of the reference signal, the second resource pattern includes at least one first basic pattern, the first indication information indicates a relationship between the first basic pattern and a second reference resource pattern, and the second reference resource pattern is a pattern of the reference signal on a resource (for example, a time domain unit, a frequency domain unit, or a space domain unit), or the second reference resource pattern is a predefined or preconfigured pattern. For the method, refer to the descriptions in the method 200. Details are not described herein again.

Based on this implementation, in step 1102, receiving or sending the reference signal based on the response to the third indication information includes: The first device receives or sends the reference signal based on the first indication information.

The foregoing describes, with reference to the method 1100, the related solution in which the first device recommends the resource pattern of the reference signal. It may be understood that the method 1100 and the method 200 may be used in combination, or may be used separately. This is not limited. A combination of the method 1100 and the method 200 is used as an example. Before step 201 is performed, step 1101 is first performed. Specifically, the first device sends the third indication information to the second device. If the resource pattern (namely, the second resource pattern) that is of the reference signal and that is determined by the second device is different from the resource pattern (namely, the first resource pattern) that is of the reference signal and that is indicated by the first device by using the third indication information, the second device sends the first indication information to the first device, and then the first device receives or sends the reference signal based on the first indication information.

For ease of understanding, an example in which the first device is a terminal device, the second device is a network device, the first information is referred to as signaling #1, and the second information is referred to as signaling #2 is used below for description with reference to a possible form of the reference signal. For content that is not described in detail below, refer to the descriptions in the method 200 and the method 1100. Details are not described below again.

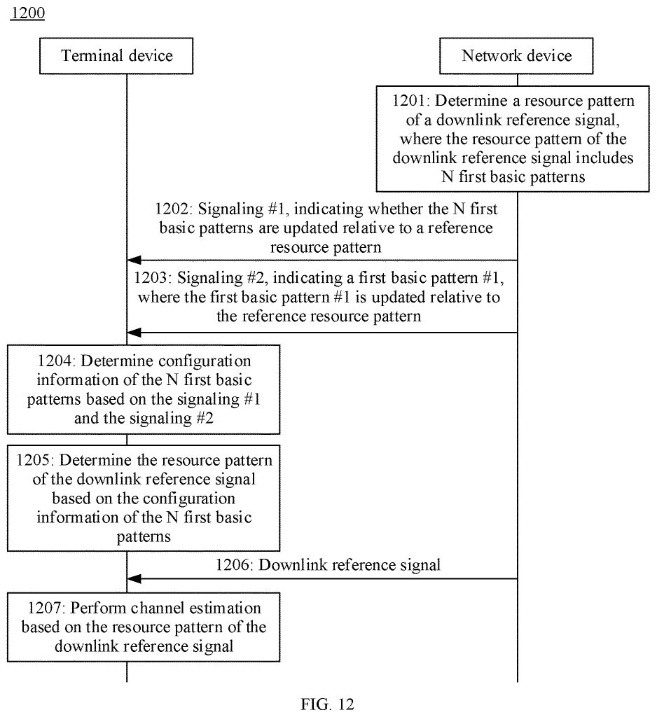

FIG. 12 is a schematic flowchart of a signal transmission method 1200 according to an embodiment. The method 1200 may be applied to the method 200. In the method 1200, it is assumed that the reference signal is a downlink reference signal (for example, a CSI-RS or a DMRS). The method 1200 shown in FIG. 12 may include the following steps.
1201: The network device determines a resource pattern of the downlink reference signal, where the resource pattern of the downlink reference signal includes N first basic patterns.

N is an integer greater than 1. That the resource pattern of the downlink reference signal includes the N first basic patterns means that the resource pattern of the downlink reference signal is obtained by combining the N first basic patterns.
1202: The network device sends the signaling #1 to the terminal device, where the signaling #1 indicates whether the N first basic patterns are updated relative to a reference resource pattern.

Specifically, the signaling #1 may indicate whether configuration information of each of the N first basic patterns is updated relative to the reference resource pattern.

Optionally, that the signaling #1 indicates whether the N first basic patterns are updated relative to the reference resource pattern includes the following several implementations.

In a possible implementation, the network device sends one piece of signaling #1 to the terminal device, where the signaling #1 indicates whether the N first basic patterns are updated relative to the reference resource pattern.

In another possible implementation, the network device sends N pieces of signaling #1 to the terminal device, where the N pieces of signaling #1 indicate whether the N first basic patterns are updated relative to the reference resource pattern. Specifically, each piece of signaling #1 indicates whether one first basic pattern is updated relative to the reference resource pattern.

In another possible implementation, the network device sends X pieces of signaling #1 to the terminal device, where the X pieces of signaling #1 indicate whether the N first basic patterns are updated relative to the reference resource pattern, and X is an integer greater than 1 and less than N. For example, X=2. One piece of signaling #1 indicates whether a part of the N first basic patterns are updated relative to the reference resource pattern, and the other piece of signaling #1 indicates whether remaining first basic patterns in the N first basic patterns are updated relative to the reference resource pattern.

For the signaling #1, refer to the related descriptions in the method 200. Details are not described herein again.

Optionally, the reference resource pattern includes at least one second basic pattern. That the signaling #1 indicates whether the N first basic patterns are updated relative to the reference resource pattern may be that the signaling #1 indicates whether the first basic pattern is updated relative to the second basic pattern. For the reference resource pattern, refer to the related descriptions in the method 200. Details are not described herein again.
1203: The network device sends the signaling #2 to the terminal device, where the signaling #2 indicates a first basic pattern #1, and the first basic pattern #1 is updated relative to the reference resource pattern.

If a first basic pattern (for example, the first basic pattern #1) in the N first basic patterns is updated relative to the reference resource pattern, the network device sends the signaling #2 to the terminal device, and indicates the first basic pattern by using the signaling #2. Correspondingly, if none of the N first basic patterns is updated relative to the reference resource pattern, the network device may not send the signaling #2 to the terminal device. For ease of description, in FIG. 12, an example in which the first basic pattern #1 in the N first basic patterns is updated relative to the reference resource pattern is mainly used for description. It may be understood that embodiments are not limited thereto.

Optionally, that the signaling #2 indicates the first basic pattern #1 includes the following several implementations.

In a first possible implementation, the signaling #2 indicates configuration information of the first basic pattern #1. Specifically, if the signaling #1 indicates that the first basic pattern #1 is updated relative to the reference resource pattern, the configuration information of the first basic pattern #1 is indicated by the signaling #2.

In a second possible implementation, the signaling #2 indicates an updated parameter of the first basic pattern #1. Specifically, if the signaling #1 indicates that one or more parameters in the first basic pattern #1 are updated relative to the reference resource pattern, the one or more parameters in the configuration information of the first basic pattern #1 may be indicated by the signaling #2, and another parameter that is not updated may not be indicated, to reduce signaling overheads.

For the signaling #2, refer to the related descriptions of the signaling #2 in the method 200. Details are not described herein again.
1204: The terminal device determines configuration information of the N first basic patterns based on the signaling #1 and the signaling #2.
1205: The terminal device determines the resource pattern of the downlink reference signal based on the configuration information of the N first basic patterns.
1206: The network device sends the downlink reference signal to the terminal device.
1207: The terminal device performs channel estimation based on the resource pattern of the downlink reference signal.

Specifically, the terminal device receives the downlink reference signal based on the resource pattern of the downlink reference signal, and performs channel estimation based on the received downlink reference signal.

Based on the foregoing technical solution, the network device may indicate, by using two levels of signaling, namely, the signaling #1 and the signaling #2, whether the N first basic patterns in the resource pattern of the downlink reference signal are updated relative to the reference resource pattern, and information about an updated first basic pattern. In this way, the resource pattern of the downlink reference signal (for example, a resource pattern of a sparse downlink reference signal) can be flexibly indicated, and signaling overheads caused by indicating the resource pattern of the downlink reference signal can be reduced.

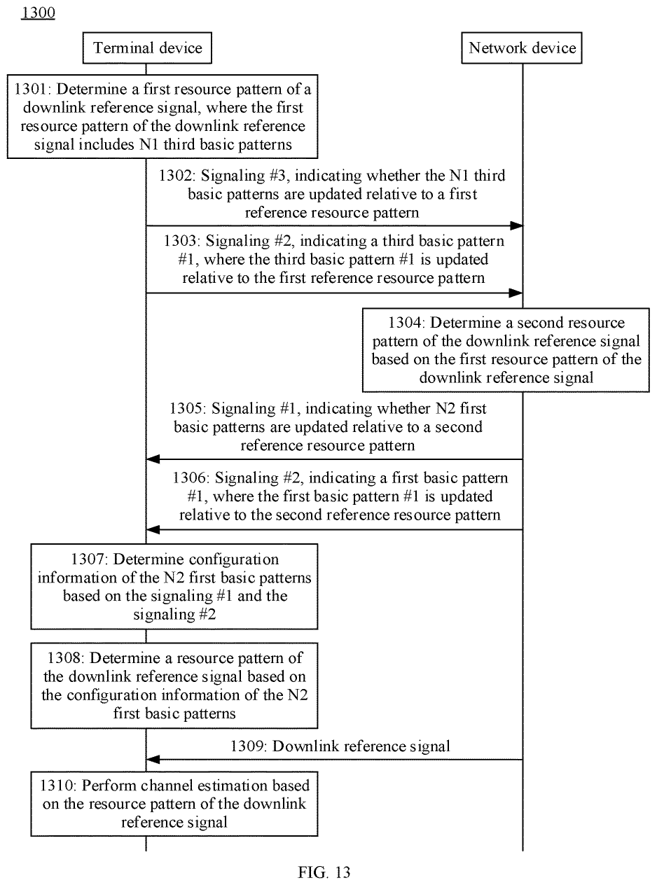

FIG. 13 is a schematic flowchart of a method 1300 according to another embodiment. The method 1300 may be applied to the method 1100. In the method 1300, it is assumed that a reference signal is a downlink reference signal. The method 1300 shown in FIG. 13 may include the following steps.
1301: A terminal device determines a first resource pattern of the downlink reference signal, where the first resource pattern of the downlink reference signal includes N1 third basic patterns.

N1 is an integer greater than 1.

For step 1301, refer to step 1101. Details are not described herein again.
1302: The terminal device sends signaling #3 to a network device, where the signaling #3 indicates whether the N1 third basic patterns are updated relative to a first reference resource pattern.

For the signaling #3, refer to the signaling #1 in the method 200.
1303: The terminal device sends signaling #4 to the network device, where the signaling #4 indicates a third basic pattern #1, and the third basic pattern #1 is updated relative to the first reference resource pattern.

For the signaling #4, refer to the signaling #2 in the method 200.

Steps 1302 and 1303 are similar to steps 1202 and 1203, and a difference lies in that in steps 1202 and 1203, the network device indicates the resource pattern of the downlink reference signal to the terminal device (that is, indicates the resource pattern by using the signaling #1 and the signaling #2); and in steps 1302 and 1303, the terminal device indicates the resource pattern of the downlink reference signal to the network device (that is, indicates the resource pattern by using the signaling #3 and the signaling #4). In addition, for differentiation, a reference resource pattern used for comparison with the third basic pattern is referred to as the first reference resource pattern.
1304: The network device determines a second resource pattern of the downlink reference signal based on the first resource pattern of the downlink reference signal

The second resource pattern of the downlink reference signal is a resource pattern that is of the downlink reference signal and that is configured by the network device for the terminal device.

The second resource pattern of the downlink reference signal includes N2 first basic patterns, where N2 is an integer greater than 1. N2 and N1 may be the same or different. This is not limited.

In a possible scenario, the second resource pattern of the downlink reference signal is the same as the first resource pattern of the downlink reference signal. For this scenario, refer to the scenario 1 in the method 1100. Details are not described herein again. Further, in the scenario 1, the method 1300 may further include steps 1309 and 1310.

In another possible scenario, the second resource pattern of the downlink reference signal is different from the first resource pattern of the downlink reference signal. In this scenario, the network device may indicate the second resource pattern of the downlink reference signal to the terminal device. Optionally, in this scenario, the method 1300 further includes steps 1305 to 1308.
1305: The network device sends signaling #1 to the terminal device, where the signaling #1 indicates whether the N2 first basic patterns are updated relative to a second reference resource pattern.
1306: The network device sends signaling #2 to the terminal device, where the signaling #2 indicates a first basic pattern #1, and the first basic pattern #1 is updated relative to the second reference resource pattern.

Steps 1302 and 1303 are similar to steps 1202 and 1203, and a difference lies in that in the method 1300, in a possible implementation, the second reference resource pattern in step 1305 may alternatively be the first resource pattern of the downlink reference signal or any one or more third basic patterns in the N1 third basic patterns.
1307: The terminal device determines configuration information of the N2 first basic patterns based on the signaling #1 and the signaling #2.
1308: The terminal device determines a resource pattern of the downlink reference signal based on the configuration information of the N2 first basic patterns.

The resource pattern that is of the downlink reference signal and that is determined by the terminal device is the foregoing second resource pattern.
1309: The network device sends the downlink reference signal to the terminal device.

For example, if the resource pattern of the downlink reference signal is the first resource pattern, the network device sends the downlink reference signal based on the first resource pattern.

For another example, if the resource pattern of the downlink reference signal is the second resource pattern, the network device sends the downlink reference signal based on the second resource pattern.
1310: The terminal device performs channel estimation based on the resource pattern of the downlink reference signal.

Specifically, the terminal device receives the downlink reference signal based on the resource pattern of the downlink reference signal, and performs channel estimation based on the received downlink reference signal.

Based on the foregoing technical solution, the terminal device may recommend the resource pattern of the downlink reference signal to the network device, for example, indicate, to the network device by using two levels of signaling (namely, the signaling #3 and the signaling #4), the resource pattern of the downlink reference signal recommended by the terminal device. In addition, if the resource pattern configured by the network device is different from the resource pattern indicated by the terminal device, the network device may further indicate the resource pattern of the downlink reference signal by using two levels of signaling (namely, the signaling #1 and the signaling #2). In this way, the resource pattern of the downlink reference signal (for example, a resource pattern of a sparse downlink reference signal) can be flexibly indicated, and signaling overheads caused by indicating the resource pattern of the downlink reference signal can be reduced.

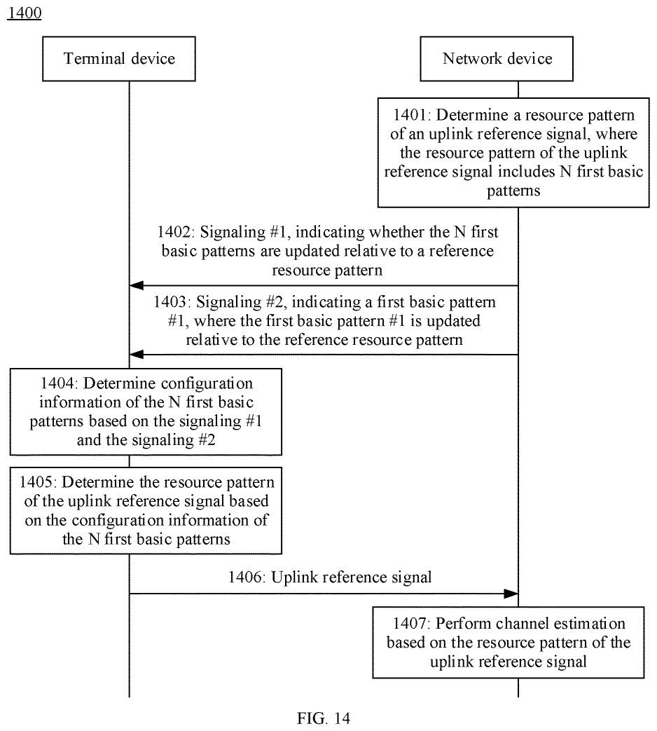

FIG. 14 is a schematic flowchart of a method 1400 according to another embodiment. The method 1400 may be applied to the method 200. In the method 1400, it is assumed that a reference signal is an uplink reference signal (for example, an SRS or a DMRS). The method 1400 shown in FIG. 14 may include the following steps.
1401: A network device determines a resource pattern of the uplink reference signal, where the resource pattern of the uplink reference signal includes N first basic patterns.
1402: The network device sends signaling #1 to a terminal device, where the signaling #1 indicates whether the N first basic patterns are updated relative to a reference resource pattern.
1403: The network device sends signaling #2 to the terminal device, where the signaling #2 indicates a first basic pattern #1, and the first basic pattern #1 is updated relative to the reference resource pattern.
1404: The terminal device determines configuration information of the N first basic patterns based on the signaling #1 and the signaling #2.
1405: The terminal device determines the resource pattern of the uplink reference signal based on the configuration information of the N first basic patterns.

For steps 1401 to 1405, refer to steps 1201 to 1205 in the method 1200. Details are not described herein again.
1406: The terminal device sends the uplink reference signal based on the resource pattern of the uplink reference signal.
1407: The network device performs channel estimation based on the resource pattern of the uplink reference signal.

Specifically, the network device receives the uplink reference signal based on the resource pattern of the uplink reference signal, and then performs channel estimation based on the uplink reference signal.

Based on the foregoing technical solution, the network device may indicate, by using two levels of signaling, namely, the signaling #1 and the signaling #2, whether the N first basic patterns in the resource pattern of the uplink reference signal are updated relative to the reference resource pattern, and information about an updated first basic pattern. In this way, the resource pattern of the uplink reference signal (for example, a resource pattern of a sparse uplink reference signal) can be flexibly indicated, and signaling overheads caused by indicating the resource pattern of the uplink reference signal can be reduced.

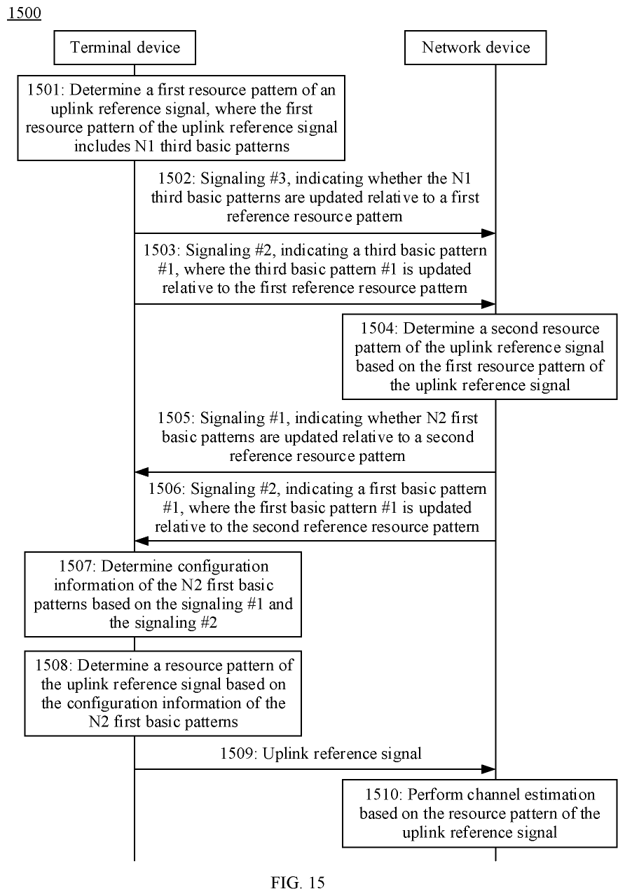

FIG. 15 is a schematic flowchart of a method 1500 according to another embodiment.

The method 1500 may be applied to the method 1100. In the method 1500, it is assumed that a reference signal is an uplink reference signal. The method 1500 shown in FIG. 15 may include the following steps.
1501: A terminal device determines a first resource pattern of the uplink reference signal, where the first resource pattern of the uplink reference signal includes N1 third basic patterns.
1502: The terminal device sends signaling #3 to a network device, where the signaling #3 indicates whether the N1 third basic patterns are updated relative to a first reference resource pattern.
1503: The terminal device sends signaling #4 to the network device, where the signaling #4 indicates a third basic pattern #1, and the third basic pattern #1 is updated relative to the first reference resource pattern.
1504: The network device determines a second resource pattern of the uplink reference signal based on the first resource pattern of the uplink reference signal.

Optionally, the method 1500 further includes steps 1505 to 1508.
1505: The network device sends signaling #1 to the terminal device, where the signaling #1 indicates whether N2 first basic patterns are updated relative to a second reference resource pattern.
1506: The network device sends signaling #2 to the terminal device, where the signaling #2 indicates a first basic pattern #1, and the first basic pattern #1 is updated relative to the second reference resource pattern.
1507: The terminal device determines configuration information of the N2 first basic patterns based on the signaling #1 and the signaling #2.
1508: The terminal device determines a resource pattern of the uplink reference signal based on the configuration information of the N2 first basic patterns.

For steps 1501 to 1508, refer to steps 1301 to 1308 in the method 1300. Details are not described herein again.
1509: The terminal device sends the uplink reference signal to the network device.
1510: The network device performs channel estimation based on the resource pattern of the uplink reference signal.

Specifically, the network device receives the uplink reference signal based on the resource pattern of the uplink reference signal, and performs channel estimation based on the received uplink reference signal.

For the method 1500, refer to the method 1300. A difference lies in that the method 1300 relates to the downlink reference signal, and the method 1500 relates to the uplink reference signal.

It may be understood that the method 1200 to the method 1500 are mainly described by using an example in which channel estimation is performed based on a reference signal. It may be understood that a type, a form, and a function of the reference signal are not limited, and any reference signal is applicable to embodiments.

It may be further understood that, in embodiments, position distribution of the reference signal on a time domain unit (for example, a slot) or position distribution of the reference signal on a frequency domain unit is mentioned a plurality of times. A person skilled in the art may understand a meaning of the position distribution. Position distribution of the reference signal on a time domain unit is used as an example. Position distribution of the reference signal on a time domain unit (for example, a slot 0 or a slot 1) may specifically indicate frequency domain resource position distribution of an antenna port or an antenna port group of the reference signal on the time domain unit, or frequency domain resource position distribution of an antenna port or an antenna port group of the reference signal on the time domain unit and a frequency domain unit. Position distribution of the reference signal on the frequency domain unit is similar. Details are not described herein again. In addition, in some embodiments, frequency domain resource position distribution of the reference signal is mainly used as an example for description. This is not limited. Specifically, the resource pattern of the reference signal may reflect time-frequency resource position distribution, time domain resource position distribution, or frequency domain resource position distribution of an antenna port or an antenna port group of the reference signal on the time domain unit. Position distribution of the reference signal on the frequency domain unit is similar. Details are not described herein again.

It may be further understood that interaction between the terminal device and the network device is mainly used as an example for description. This disclosure is not limited thereto. The terminal device may be replaced with a receive end device, and the receive end device may be a terminal device or a network device. The network device may be replaced with a transmit end device, and the transmit end device may be a terminal device or a network device. For example, the “terminal device” may be replaced with a “first terminal device”, and the “network device” may be replaced with a “second terminal device”.

It may be further understood that some optional features in embodiments may not depend on another feature in some scenarios, or may be combined with another feature in some scenarios. This is not limited.

It may be further understood that the solutions in embodiments may be appropriately combined for use, and explanations or descriptions of terms in embodiments may be mutually referenced or explained in the embodiments. This is not limited.

It may be further understood that in the method embodiments, the method and the operations implemented by the terminal device may be implemented by a component (for example, a chip or a circuit) of the terminal device. In addition, the method and the operations implemented by the network device may be implemented by a component (for example, a chip or a circuit) of the network device. This is not limited.

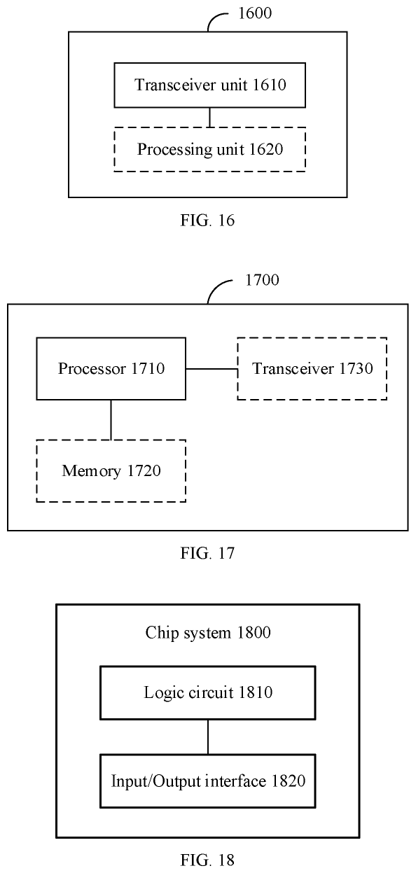

The foregoing describes in detail the methods provided in embodiments with reference to FIG. 2 to FIG. 15. The following describes in detail apparatuses provided in embodiments with reference to FIG. 16 to FIG. 18. It should be understood that descriptions of apparatus embodiments correspond to the descriptions of the method embodiments. Therefore, for content that is not described in detail, refer to the foregoing method embodiments. For brevity, details are not described herein.

FIG. 16 is a diagram of a communication apparatus 1600 according to an embodiment. The apparatus 1600 includes a transceiver unit 1610. The transceiver unit 1610 may be configured to implement a corresponding communication function. The transceiver unit 1610 may alternatively be referred to as a communication interface or a communication unit. Optionally, the apparatus 1600 further includes a processing unit 1620. The processing unit 1620 may be configured to perform processing, for example, determine a resource pattern.

Optionally, the apparatus 1600 may further include a storage unit. The storage unit may be configured to store instructions and/or data, and the processing unit 1620 may read the instructions and/or the data in the storage unit, so that the apparatus implements the foregoing method embodiments.

In a first possible design, the apparatus 1600 may be the first device (for example, the first device in FIG. 2 or FIG. 11, or the terminal device in FIG. 12 to FIG. 15) in the foregoing embodiments, and the apparatus 1600 may implement steps or procedures performed by the first device in the foregoing method embodiments. The transceiver unit 1610 may be configured to perform a receiving and sending-related operation (for example, an operation of sending and/or receiving data or a message) of the first device in the foregoing method embodiments. The processing unit 1620 may be configured to perform a processing-related operation of the first device in the foregoing method embodiments, or an operation other than receiving and sending (for example, an operation other than sending and/or receiving data or a message).

In a possible implementation, the transceiver unit 1610 is configured to receive first indication information, where the first indication information is used to determine a resource pattern of a reference signal, the resource pattern of the reference signal includes at least one first basic pattern, and the first indication information indicates a relationship between the first basic pattern and a reference resource pattern; and the transceiver unit 1610 is further configured to receive or send the reference signal based on the first indication information. Optionally, the processing unit 1620 is configured to determine the resource pattern of the reference signal.

Optionally, the first indication information includes first information, and that the first indication information indicates the relationship between the first basic pattern and the reference resource pattern includes: The first information indicates whether the first basic pattern is updated relative to the reference resource pattern.

Optionally, the first information indicates that the first basic pattern is updated relative to the reference resource pattern, the first indication information further includes second information, and the second information indicates the first basic pattern.

Optionally, the first information indicates that a first parameter in configuration information of the first basic pattern is updated relative to a first parameter in configuration information of the reference resource pattern, and the second information indicates the first parameter in the configuration information of the first basic pattern.

Optionally, the reference resource pattern includes at least one second basic pattern, and that the first indication information indicates the relationship between the first basic pattern and the reference resource pattern includes: The first indication information indicates a relationship between the first basic pattern and the second basic pattern.

Optionally, the configuration information of the first basic pattern includes one or more of the following information: a start position of the first basic pattern, a domain corresponding to the first basic pattern, and a resource that is of the reference signal and that is indicated by the first basic pattern, where the domain corresponding to the first basic pattern is any one of the following: a time domain, a frequency domain, and a space domain.

Optionally, the resource that is of the reference signal and that is indicated by the first basic pattern includes at least one of the following information: a total quantity of resources corresponding to the first basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the first basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

Optionally, the transceiver unit 1610 is further configured to receive second indication information, where the second indication information indicates at least one bandwidth resource, and the at least one bandwidth resource is associated with the resource pattern of the reference signal.

Optionally, the at least one bandwidth resource includes a first bandwidth resource and a second bandwidth resource, and a resource pattern of the reference signal on the second bandwidth resource is the same as a resource pattern of the reference signal on the first bandwidth resource; or the first indication information includes the first information, the first information indicates whether the first basic pattern is updated relative to the reference resource pattern, and first information corresponding to the second bandwidth resource is the same as first information corresponding to the first bandwidth resource; or a relationship between a first basic pattern corresponding to the second bandwidth resource and the reference resource pattern is the same as a relationship between a first basic pattern corresponding to the first bandwidth resource and the reference resource pattern.

Optionally, the transceiver unit 1610 is further configured to send third indication information, where the third indication information indicates a recommended resource pattern of the reference signal.

Optionally, the reference resource pattern is the recommended resource pattern of the reference signal.

Optionally, the resource pattern of the reference signal is a resource pattern of the reference signal on a first resource, and the reference resource pattern is a resource pattern of the reference signal on a second resource, where the first resource is different from the second resource; or the reference resource pattern is a predefined or preconfigured pattern.

Optionally, that the reference resource pattern is the resource pattern of the reference signal on the second resource includes any one of the following: The reference resource pattern is a resource pattern of the reference signal on at least one time domain unit, the reference resource pattern is a resource pattern of the reference signal on at least one frequency domain unit, the reference resource pattern is a resource pattern of the reference signal on at least one antenna port, or the reference resource pattern is a resource pattern of the reference signal on at least one antenna port group.

In a second possible design, the apparatus 1600 may be the second device (for example, the second device in FIG. 2 or FIG. 11, or the network device in FIG. 12 to FIG. 15) in the foregoing embodiments, and the apparatus 1600 may implement steps or procedures performed by the second device in the foregoing method embodiments. The transceiver unit 1610 may be configured to perform a receiving and sending-related operation (for example, an operation of sending and/or receiving data or a message) of the second device in the foregoing method embodiments. The processing unit 1620 may be configured to perform a processing-related operation of the second device in the foregoing method embodiments, or an operation other than receiving and sending (for example, an operation other than sending and/or receiving data or a message).

In a possible implementation, the transceiver unit 1610 is configured to send first indication information, where the first indication information is used to determine a resource pattern of a reference signal, the resource pattern of the reference signal includes at least one first basic pattern, and the first indication information indicates a relationship between the first basic pattern and a reference resource pattern; and the transceiver unit 1610 is further configured to receive or send the reference signal based on the first indication information. Optionally, the processing unit 1620 is configured to determine the resource pattern of the reference signal.

Optionally, the first indication information includes first information, and that the first indication information indicates the relationship between the first basic pattern and the reference resource pattern includes: The first information indicates whether the first basic pattern is updated relative to the reference resource pattern.

Optionally, the first information indicates that the first basic pattern is updated relative to the reference resource pattern, the first indication information further includes second information, and the second information indicates the first basic pattern.

Optionally, the first information indicates that a first parameter in configuration information of the first basic pattern is updated relative to a first parameter in configuration information of the reference resource pattern, and the second information indicates the first parameter in the configuration information of the first basic pattern.

Optionally, the reference resource pattern includes at least one second basic pattern, and that the first indication information indicates the relationship between the first basic pattern and the reference resource pattern includes: The first indication information indicates a relationship between the first basic pattern and the second basic pattern.

Optionally, the configuration information of the first basic pattern includes one or more of the following information: a start position of the first basic pattern, a domain corresponding to the first basic pattern, and a resource that is of the reference signal and that is indicated by the first basic pattern, where the domain corresponding to the first basic pattern is any one of the following: a time domain, a frequency domain, and a space domain.

Optionally, the resource that is of the reference signal and that is indicated by the first basic pattern includes at least one of the following information: a total quantity of resources corresponding to the first basic pattern, a total resource quantity of a resource occupied by the reference signal, a resource density of a resource occupied by the reference signal, a start position of a resource occupied by the reference signal, an end position of a resource occupied by the reference signal, an index of a preset pattern used to obtain the first basic pattern, an offset of a resource occupied by the reference signal relative to the preset pattern, an offset direction of a resource occupied by the reference signal relative to the preset pattern, and a resource density variation of a resource occupied by the reference signal relative to the preset pattern.

Optionally, the transceiver unit 1610 is further configured to send second indication information, where the second indication information indicates at least one bandwidth resource, and the at least one bandwidth resource is associated with the resource pattern of the reference signal.

Optionally, the at least one bandwidth resource includes a first bandwidth resource and a second bandwidth resource, and a resource pattern of the reference signal on the second bandwidth resource is the same as a resource pattern of the reference signal on the first bandwidth resource; or the first indication information includes the first information, the first information indicates whether the first basic pattern is updated relative to the reference resource pattern, and first information corresponding to the second bandwidth resource is the same as first information corresponding to the first bandwidth resource; or a relationship between a first basic pattern corresponding to the second bandwidth resource and the reference resource pattern is the same as a relationship between a first basic pattern corresponding to the first bandwidth resource and the reference resource pattern.

Optionally, the transceiver unit 1610 is further configured to receive third indication information, where the third indication information indicates a recommended resource pattern of the reference signal.

Optionally, the reference resource pattern is the recommended resource pattern of the reference signal.

Optionally, the resource pattern of the reference signal is a resource pattern of the reference signal on a first resource, and the reference resource pattern is a resource pattern of the reference signal on a second resource, where the first resource is different from the second resource; or the reference resource pattern is a predefined or preconfigured pattern.

Optionally, that the reference resource pattern is the resource pattern of the reference signal on the second resource includes any one of the following: The reference resource pattern is a resource pattern of the reference signal on at least one time domain unit, the reference resource pattern is a resource pattern of the reference signal on at least one frequency domain unit, the reference resource pattern is a resource pattern of the reference signal on at least one antenna port, or the reference resource pattern is a resource pattern of the reference signal on at least one antenna port group.

It should be understood that a specific process in which the units perform the foregoing corresponding steps is described in detail in the foregoing method embodiments, and for brevity, details are not described herein again.

It should be further understood that the apparatus 1600 is presented in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 1600 may be specifically the communication apparatus in the foregoing embodiments, and may be configured to perform procedures and/or steps corresponding to the communication apparatus in the foregoing method embodiments. To avoid repetition, details are not described herein again.

The apparatus 1600 in the foregoing solutions has a function of implementing corresponding steps performed by the communication apparatus in the foregoing methods. The function may be implemented by hardware, or may be implemented by hardware executing corresponding software. The hardware or software includes one or more modules corresponding to the function. For example, a transceiver unit may be replaced with a transceiver (for example, a sending unit in the transceiver unit may be replaced with a transmitter, and a receiving unit in the transceiver unit may be replaced with a receiver), and another unit like a processing unit may be replaced with a processor, to separately perform sending and receiving operations and a related processing operation in the method embodiments.

In addition, the transceiver unit 1610 may alternatively be a transceiver circuit (for example, may include a receiving circuit and a sending circuit), and the processing unit may be a processing circuit.

It should be noted that the apparatus in FIG. 16 may be the communication device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

FIG. 17 is a diagram of another communication apparatus 1700 according to an embodiment. The apparatus 1700 includes a processor 1710. The processor 1710 is coupled to a memory 1720. The memory 1720 is configured to store a computer program or instructions and/or data. The processor 1710 is configured to: execute the computer program or the instructions stored in the memory 1720, or read the data stored in the memory 1720, to perform the methods in the foregoing method embodiments.

Optionally, there are one or more processors 1710.

Optionally, there are one or more memories 1720.

Optionally, the memory 1720 and the processor 1710 may be integrated together or separately disposed.

Optionally, as shown in FIG. 17, the apparatus 1700 further includes a transceiver 1730. The transceiver 1730 is configured to receive and/or send signals. For example, the processor 1710 is configured to control the transceiver 1730 to receive and/or send signals.

For example, the processor 1710 may have a function of the processing unit 1620 shown in FIG. 16, the memory 1720 may have a function of the storage unit, and the transceiver 1730 may have a function of the transceiver unit 1610 shown in FIG. 16.

In a solution, the apparatus 1700 is configured to implement operations performed by the communication apparatus in the foregoing method embodiments.

For example, the processor 1710 is configured to execute the computer program or the instructions stored in the memory 1720, to implement related operations of the first device or the second device in the foregoing method embodiments.

The processor may be a central processing unit (CPU), or may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any other processor, or the like.

It should be further understood that the memory mentioned in this embodiment may be a volatile memory and/or a nonvolatile memory. The nonvolatile memory may be a read-only memory (ROM), a ROM (PROM), an erasable PROM (EPROM), an electrically erasable PROM (EEPROM), or a flash memory. The volatile memory may be a random-access memory (RAM). For example, the RAM may be used as an external cache. As an example instead of a limitation, the RAM includes the following plurality of forms: a static RAM (SRAM), a dynamic RAM (DRAM), a synchronous DRAM (SDRAM), a double data rate (DDR) SDRAM, an enhanced SDRAM (ESDRAM), a synchronous-link DRAM (SLDRAM), and a direct Rambus (DR) RAM.

It should be noted that when the processor is a general-purpose processor, a DSP, an ASIC, an FPGA, another programmable logic device, a discrete gate or transistor logic device, or a discrete hardware component, the memory (storage module) may be integrated into the processor.

It should be further noted that the memory described in this specification aims to include but is not limited to these memories and any memory of another suitable type.

FIG. 18 is a diagram of a chip system 1800 according to an embodiment. The chip system 1800 (or may be referred to as a processing system) includes a logic circuit 1810 and an input/output interface (I/O) 1820.

The logic circuit 1810 may be a processing circuit in the chip system 1800. The logic circuit 1810 may be coupled to a storage unit, and invoke instructions in the storage unit, so that the chip system 1800 can implement the methods and functions in embodiments. The input/output interface 1820 may be an input/output circuit in the chip system 1800, and outputs information processed by the chip system 1800, or inputs to-be-processed data or signaling information to the chip system 1800 for processing.

In a solution, the chip system 1800 is configured to implement operations performed by the communication apparatus (for example, the first device or the second device) in the foregoing method embodiments.

For example, the logic circuit 1810 is configured to implement processing-related operations performed by the communication apparatus (for example, the first device or the second device) in the foregoing method embodiments, and the input/output interface 1820 is configured to implement sending and/or receiving-related operations performed by the communication apparatus (for example, the first device or the second device) in the foregoing method embodiments.

An embodiment further provides a computer-readable storage medium. The computer-readable storage medium stores computer instructions used to implement the method performed by the communication apparatus (for example, the first device or the second device) in the foregoing method embodiments.

For example, when a computer program is executed by a computer, the computer is enabled to implement the method performed by the communication apparatus (for example, the first device or the second device) in the foregoing method embodiments.

An embodiment further provides a computer program product including instructions. When the instructions are executed by a computer, the method performed by the communication apparatus (for example, the first device or the second device) in the foregoing method embodiments is implemented.

An embodiment further provides a communication system. The communication system includes the first device and/or the second device in the foregoing embodiments. For example, the system includes the first device and the second device in FIG. 2 or FIG. 11. For another example, the system includes the terminal device and the network device in FIG. 12, FIG. 13, FIG. 14, or FIG. 15.

For explanations and beneficial effect of related content in any one of the apparatuses provided above, refer to the corresponding method embodiment provided above. Details are not described herein again.

In the several embodiments provided, it should be understood that the disclosed apparatus and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings, direct couplings, or communication connections may be implemented through some interfaces. Indirect couplings or communication connections between the apparatuses or units may be implemented in an electronic form, a mechanical form, or another form.

All or some of the foregoing embodiments may be implemented by software, hardware, firmware, or any combination thereof. When software is used for implementation, all or some of the methods may be implemented in a form of a computer program product. The computer program product includes one or more computer instructions. When the computer program instructions are loaded and executed on a computer, the procedure or functions according to embodiments are all or partially generated. The computer may be a general-purpose computer, a dedicated computer, a computer network, or another programmable apparatus. For example, the computer may be a personal computer, a server, or a network device. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid-state disk (SSD)), or the like. For example, the usable medium may include but is not limited to any medium that can store program code, such as a USB flash drive, a removable hard disk, a ROM, a RAM, a magnetic disk, or an optical disc.

The foregoing descriptions are merely specific implementations, but are not intended to limit the protection scope of this disclosure. Any variation or replacement readily figured out by a person skilled in the art within the technical scope disclosed shall fall within the protection scope of this disclosure. Therefore, the protection scope of this disclosure shall be subject to the protection scope of the claims.

1. A method comprising:
receiving first indication information that determines a resource pattern of a reference signal, wherein the resource pattern comprises a first basic pattern, and wherein the first indication information indicates a first relationship between the first basic pattern and a reference resource pattern; and
receiving or sending the reference signal based on the first indication information.

2. The method of claim 1, wherein the first indication information comprises first information, and wherein the first indication information indicating the first relationship comprises the first information indicating whether the first basic pattern is updated relative to the reference resource pattern.

3. The method of claim 2, wherein the first information indicating whether the first basic pattern is updated relative to the reference resource pattern comprises the first information indicating the first basic pattern is updated relative to the reference resource pattern, and wherein the first indication information further comprises second information indicating the first basic pattern.

4. The method of claim 3, wherein the first information indicating the first basic pattern is updated relative to the reference resource pattern comprises the first information indicating a first parameter in first configuration information of the first basic pattern is updated relative to a second parameter in second configuration information of the reference resource pattern, and wherein the second information indicating the first basic pattern comprises the second information indicating the first parameter.

5. The method of claim 1, wherein the reference resource pattern comprises a second basic pattern, and wherein the first indication information indicating the first relationship comprises the first indication information indicating a second relationship between the first basic pattern and the second basic pattern.

6. The method of claim 4, wherein the first configuration information comprises a first start position of the first basic pattern, a domain corresponding to the first basic pattern, or a first resource that is of the reference signal and that is indicated by the first basic pattern, and wherein the domain is a time domain, a frequency domain, or a space domain.

7. A method comprising:
sending first indication information that determines a resource pattern of a reference signal, wherein the resource pattern comprises a first basic pattern, and wherein the first indication information indicates a first relationship between the first basic pattern and a reference resource pattern; and
receiving or sending the reference signal based on the first indication information.

8. The method of claim 7, wherein the first indication information comprises first information, and wherein the first indication information indicating the first relationship comprises the first information indicating whether the first basic pattern is updated relative to the reference resource pattern.

9. The method of claim 8, wherein the first information indicating whether the first basic pattern is updated relative to the reference resource pattern comprises the first information indicating the first basic pattern is updated relative to the reference resource pattern, and wherein the first indication information further comprises second information indicating the first basic pattern.

10. The method of claim 9, wherein the first information indicating the first basic pattern is updated relative to the reference source pattern comprises the first information indicating a first parameter in first configuration information of the first basic pattern is updated relative to a second parameter in second configuration information of the reference resource pattern, and wherein the second information indicating the first basic pattern comprises the second information indicating the first parameter.

11. The method of claim 7, wherein the reference resource pattern comprises a second basic pattern, and wherein the first indication information indicating the first relationship comprises the first indication information indicating a second relationship between the first basic pattern and the second basic pattern.

12. The method of claim 10, wherein the first configuration information a first start position of the first basic pattern, a domain corresponding to the first basic pattern, or a resource that is of the reference signal and that is indicated by the first basic pattern, and wherein the domain is a time domain, a frequency domain, or a space domain.

13. A communication apparatus comprising:
one or more memories configured to store instructions; and
one or more processors coupled to the one or more memories and configured to execute the instructions to enable the communication apparatus to:
receive first indication information that determines a resource pattern of a reference signal, wherein the resource pattern comprises a first basic pattern, and wherein the first indication information indicates a first relationship between the first basic pattern and a reference resource pattern; and
receive or send the reference signal based on the first indication information.

14. The communication apparatus of claim 13, wherein the first indication information comprises first information, and wherein the first indication information indicating the first relationship comprises the first information indicating whether the first basic pattern is updated relative to the reference resource pattern.

15. The communication apparatus of claim 14, wherein the first information indicating whether the first basic pattern is updated relative to the reference resource pattern comprises the first information indicating the first basic pattern is updated relative to the reference resource pattern, and wherein the first indication information further comprises second information indicating the first basic pattern.

16. The communication apparatus of claim 15, wherein the first information indicating the first basic pattern is updated relative to the reference resource pattern comprises the first information indicating a first parameter in first configuration information of the first basic pattern is updated relative to a second parameter in second configuration information of the reference resource pattern, and wherein the second information indicating the first basic pattern comprises the second information indicating the first parameter.

17. The communication apparatus of claim 13, wherein the reference resource pattern comprises a second basic pattern, and wherein the first indication information indicating the first relationship comprises the first indication information indicating a second relationship between the first basic pattern and the second basic pattern.

18. The communication apparatus of claim 16, wherein the first configuration information comprises a first start position of the first basic pattern, a domain corresponding to the first basic pattern, or a first resource that is of the reference signal and that is indicated by the first basic pattern, and wherein the domain is a time domain, a frequency domain, or a space domain.

19. The communication apparatus of claim 18, wherein the first resource comprises a total quantity of second resources corresponding to the first basic pattern, a total resource quantity of a third resource occupied by the reference signal, a resource density of a fourth resource occupied by the reference signal, a second start position of a fifth resource occupied by the reference signal, an end position of a sixth resource occupied by the reference signal, an index of a preset pattern for obtaining the first basic pattern, an offset of a seventh resource occupied by the reference signal relative to the preset pattern, an offset direction of an eighth resource occupied by the reference signal relative to the preset pattern, or a resource density variation of a ninth resource occupied by the reference signal relative to the preset pattern.

20. The communication apparatus of claim 13, wherein the one or more processors are further configured to execute the instructions to cause the communication apparatus to receive second indication information, indicating a bandwidth resource associated with the resource pattern.
